(19) United States
(12) Patent Application Publication
(10) Pub. No.: US 2026/0336518 A1
(43) Pub. Date: Oct. 29, 2026

(54) VEHICULAR OCCUPANT MONITORING SYSTEM WITH CAMERA AND NEAR INFRARED LIGHT EMITTERS AT INTERIOR REARVIEW MIRROR

(71) Applicant: Magna Mirrors of America, Inc., Holland, MI (US)

(72) Inventor: Justin E. Sobecki, Rockford, MI (US)

(21) Appl. No.: 19/660,360

(22) Filed: Apr. 28, 2026

Related U.S. Application Data
(60) Provisional application No. 63/796,468, filed on Apr. 29, 2025.
(60) Provisional application No. 63/821,507, filed on Jun. 11, 2025.

(51) Int. Cl. B60R 1/12; B60R 1/04; B60R 1/08; G02B 3/08; G02B 5/20; G02B 13/14; H04N 23/21; H04N 23/56

(52) U.S. Cl. CPC B60R 1/12; B60R 1/04; B60R 1/088; G02B 3/08; G02B 5/204; G02B 13/14; H04N 23/21; H04N 23/56; B60R 2001/1253

(57) ABSTRACT

A vehicular cabin monitoring system includes an interior rearview mirror assembly including a mirror head that accommodates a mirror reflective element, a camera, and a near infrared (NIR) light emitter. The NIR light emitter includes an NIR light source that emits NIR light that illuminates at least a portion of the interior cabin. An optic element is disposed between the NIR light source and a rear side of the mirror reflective element. NIR light emitted by the NIR light source passes through the optic element, the mirror reflective element and is directed toward a driver side of the vehicle via the optic element. The NIR light as entering the optic element has a principal beam axis at a first angle relative to the mirror reflective element, and the NIR light as exiting the optic element has a principal beam axis at a different second angle.

### CROSS REFERENCE TO RELATED APPLICATIONS

The present application claims the filing benefits of U.S. provisional application Ser. No. 63/821,507, filed Jun. 11, 2025, and U.S. provisional application Ser. No. 63/796,468, filed Apr. 29, 2025, which are hereby incorporated herein by reference in their entireties.

### FIELD OF THE INVENTION

The present invention relates generally to the field of interior rearview mirror assemblies for vehicles and, more particularly, to an interior rearview mirror assembly that includes a camera for cabin monitoring.

### BACKGROUND OF THE INVENTION

It is known to provide a mirror assembly that is adjustably mounted to an interior portion of a vehicle, such as via a double ball pivot or joint mounting configuration where the mirror head and reflective element are adjusted relative to the interior portion of a vehicle by pivotal movement about the double ball pivot configuration. The mirror head and reflective element are pivotable about either or both of the ball pivot joints by a user that is adjusting the user's rearward view.

### SUMMARY OF THE INVENTION

A vehicular cabin monitoring system includes a vehicular interior rearview mirror assembly that includes a mirror head adjustable about a mounting structure. The mounting structure is configured to mount the vehicular interior rearview mirror assembly at an interior portion of an interior cabin of a vehicle. The mirror head accommodates a mirror reflective element. A camera is accommodated by the mirror head, and, with the vehicular interior rearview mirror assembly mounted at the interior portion of the interior cabin of the vehicle, the camera views within the interior cabin of the vehicle. A near infrared (NIR) light emitter is accommodated by the mirror head. The NIR light emitter may comprise (i) a circuit element and (ii) an NIR light source. With the vehicular interior rearview mirror assembly mounted at the interior portion of the interior cabin of the vehicle, and when the NIR light emitter is electrically operated, the NIR light source emits NIR light that illuminates at least a portion of the interior cabin of the vehicle. The camera, the NIR light emitter and the mirror reflective element move together and in tandem with the mirror head when, with the vehicular interior rearview mirror assembly mounted at the interior portion of the interior cabin of the vehicle, the mirror head is adjusted about the mounting structure to provide a rearward view for a driver of the vehicle provided by the mirror reflective element. An electronic control unit (ECU) includes electronic circuitry and associated software. The electronic circuitry of the ECU includes an image processor operable to process image data transferred to the ECU that is captured by the camera. The NIR light source is disposed at a mounting side of the circuit element. The mounting side of the circuit element may be parallel to an inner or rear side or surface of the mirror reflective element. An optic element is disposed between the NIR light source and the inner surface of the mirror reflective element. With the vehicular interior rearview mirror assembly mounted at the interior portion of the interior cabin of the vehicle, and when the NIR light emitter is electrically operated, NIR light emitted by the NIR light source (i) passes through the optic element, (ii) passes through the mirror reflective element and (iii) is directed at least partially toward a driver side of the interior cabin of the vehicle via the optic element. Thus, a principal beam axis of NIR light entering the optic element is at a first angle relative to the rear side of the mirror reflective element and a principal beam axis of NIR light exiting the optic element and passing through the mirror reflective element is at a different second angle relative to the rear side of the mirror reflective element. For example, the second angle may be more toward the driver side of the vehicle, more side a passenger side of the vehicle, and/or more downward from the mirror head (e.g., for illuminating a footwell region). With the vehicular interior rearview mirror assembly mounted at the interior portion of the interior cabin of the vehicle, image data captured by the camera is processed at the ECU for monitoring the driver of the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly having a driver monitoring camera and a near infrared light emitter behind a reflective element of the interior rearview mirror assembly;

FIG. 2 is another perspective view of the interior rearview mirror assembly, showing the driver monitoring camera and light emitters without the reflective element;

FIG. 3 is an example frame of image data captured by the driver monitoring camera, showing portions of the image data used for a driver monitoring system (DMS) and an occupant monitoring system (OMS);

FIGS. 4A-4C are views of the interior rearview mirror assembly and near infrared (NIR) light emitters that are disposed at separate circuit elements that are angled or tilted relative to one another for illuminating driver regions of right hand drive (RHD) and left hand drive (LHD) vehicles;

FIG. 4D is a schematic view of the interior cabin of the vehicle, showing regions of the interior cabin illuminated by the NIR light emitters of FIGS. 4A-4C;

FIGS. 5A-5D are views of the interior rearview mirror assembly and NIR light emitters that are disposed at a main printed circuit board (PCB) of the mirror assembly, with a lens or optic element configured to direct or refract light from the NIR light emitters for illuminating the driver regions of RHD and LHD vehicles;

FIG. 5E is a schematic view of the interior cabin of the vehicle, showing regions of the interior cabin illuminated by the NIR light emitters of FIGS. 5A-5D;

FIG. 6A shows example irradiance measured during driver monitoring with the NIR light emitters of FIGS. 4A-4C operated under maximum energy conditions;

FIG. 6B shows example irradiance measured during driver monitoring with the NIR light emitters of FIGS. 4A-4C operated under maximum power conditions;

FIG. 6C shows example irradiance measured during occupant monitoring with the NIR light emitters of FIGS. 4A-4C operated under maximum energy conditions;

FIG. 7A shows example irradiance measured during driver monitoring with the NIR light emitters of FIGS. 5A-5D operated under maximum energy conditions;

FIG. 7B shows example irradiance measured during driver monitoring with the NIR light emitters of FIGS. 5A-5D operated under maximum power conditions;

FIG. 7C shows example irradiance measured during occupant monitoring with the NIR light emitters of FIGS. 5A-5D operated under maximum energy conditions;

FIG. 8 is a graph charting driver drowsiness behaviors over time;

FIG. 9 is a schematic view of the interior cabin of the vehicle showing regions viewed by the driver of the vehicle;

FIG. 10 shows example fields of view for a 5 megapixel camera and a 1.5 megapixel camera;

FIG. 11 shows example frames of image data and detected eye position for a male driver with a size in the 95th percentile;

FIG. 12 shows example frames of image data and detected eye position for a female driver with a size in the 5th percentile;

FIG. 13 shows example frames of image data and detected eye position for a female driver with a size below the 5th percentile;

FIGS. 14A and 14B are views of the interior rearview mirror assembly and additional NIR light emitters that are disposed at the main PCB of the mirror assembly, with a lens or optic element configured to direct or refract light from the NIR light emitters for illuminating the driver regions of RHD and LHD vehicles;

FIG. 14C is a schematic view of the interior cabin of the vehicle, showing regions of the interior cabin illuminated by the NIR light emitters of FIGS. 14A and 14B;

FIG. 15 shows example irradiance measured during driver monitoring with the NIR light emitters of FIGS. 14A and 14B operated under maximum energy conditions;

FIG. 16A is a perspective view of NIR light emitters disposed at the main PCB of the mirror assembly and behind the lens or optic element, with the NIR light emitters for illuminating different regions of the interior cabin of the vehicle arranged vertically relative to one another at a side portion of the PCB;

FIG. 16B is a schematic view of the interior cabin of the vehicle, showing regions of the interior cabin illuminated by the NIR light emitters of FIG. 16A with the mirror assembly having an electrochromic mirror reflective element;

FIG. 16C is a schematic view of the interior cabin of the vehicle, showing regions of the interior cabin illuminated by the NIR light emitters of FIG. 16A with the mirror assembly having a prismatic mirror reflective element;

FIG. 16D is a flowchart for an example pattern of capturing image data representative of NIR light for driver monitoring and occupant monitoring and capturing image data representative of visible light;

FIG. 17A shows example irradiance measured during driver monitoring with the NIR light emitters of FIG. 16A operated under maximum energy conditions with the mirror assembly having an electrochromic mirror reflective element;

FIG. 17B shows example irradiance measured during driver monitoring with the NIR light emitters of FIG. 16A operated under maximum energy conditions with a reduced current draw and with the mirror assembly having a prismatic mirror reflective element;

FIG. 17C shows example irradiance measured during driver monitoring with the NIR light emitters of FIG. 16A operated under maximum power conditions with an increased current draw and with the mirror assembly having an electrochromic mirror reflective element;

FIG. 17D shows example irradiance measured during driver monitoring with the NIR light emitters of FIG. 16A operated under maximum power conditions with an increased current draw and with the mirror assembly having a prismatic mirror reflective element;

FIG. 17E shows example irradiance measured during driver monitoring with the NIR light emitters of FIG. 16A operated under maximum energy conditions with the mirror assembly having a prismatic mirror reflective element;

FIG. 17F shows example irradiance measured during driver monitoring with the NIR light emitters of FIG. 16A operated under maximum power conditions with an increased current draw and with the mirror assembly having a prismatic mirror reflective element;

FIG. 18 shows example irradiance concentration for light emitted by the NIR light emitters that does not pass through the lens or optic element compared to light that passes through the lens or optic element;

FIGS. 19 and 20 are views of a printed circuit board (PCB) of the mirror assembly that accommodates the driver monitoring camera and NIR light emitters, with a red glow filter optic element disposed in front of the NIR light emitters;

FIGS. 21 and 22 are views of the red glow filter optic element of FIGS. 19 and 20;

FIG. 23 shows example fields of illumination of the NIR light emitters of FIGS. 19 and 20;

FIGS. 24-26 are views of another red glow filter optic element;

FIGS. 27 and 28 are views of the red glow filter optic element of FIGS. 24-26 installed in front of the NIR light emitters;

FIG. 29 shows example fields of illumination of the NIR light emitters through the red glow filter optic element of FIGS. 24-26;

FIG. 30 shows example irradiance measured during driver monitoring with the NIR light emitters through the red glow filter optic element of FIGS. 24-26;

FIG. 31 is a schematic view of the PCB with the red glow filter optic element of FIGS. 24-26, showing example dimensions;

FIG. 32 is a perspective view of a mirror assembly with the red glow filter optic element of FIGS. 24-26, with the mirror reflective element removed from an adhesive element;

FIG. 33 is a perspective view of the mirror assembly with the red glow filter optic element of FIGS. 24-26, with the adhesive element removed from a mirror back plate;

FIG. 34 is a perspective view of the mirror assembly with the red glow filter optic element of FIGS. 24-26, with the mirror back plate removed from a mirror casing;

FIGS. 35 and 36 are views of the PCB with the red glow filter optic element of FIGS. 24-26; and

FIG. 37 is a sectional view of the PCB and the red glow filter optic element of FIGS. 24-26.

### DESCRIPTION OF THE PREFERRED EMBODIMENTS

In some jurisdictions, regulations may require a driver monitoring system (DMS) and/or occupant monitoring system (OMS) of a vehicle to detect unsafe conditions or behaviors of the driver or vehicle occupants. For instance, the European New Car Assessment Program provides information and ratings on the safety performance of new vehicles and a driver monitoring category is a key category for a new vehicle to receive a top safety performance rating. Examples of required capabilities for DMS include driver drowsiness and attention warning (DDAW) and advanced driver distraction warning (ADDW). Further, assessment programs may assess vehicle safety according to various detailed protocols that extend beyond DDAW and ADDW, such as to gaze locations for the driver, phone use, and the like, to generate safety ratings for vehicles. As discussed further below, an interior rearview mirror assembly includes one or more cameras at a mirror head of the mirror assembly, where the one or more cameras capture image data of the driver region and a front passenger region throughout a range of motion of the mirror head. That is, to detect unsafe conditions and behaviors at the driver region and front passenger region of the cabin, the one or more DMS and/or OMS cameras have a field of view that at least partially views the driver region and front passenger region of the cabin at all positions of the mirror head.

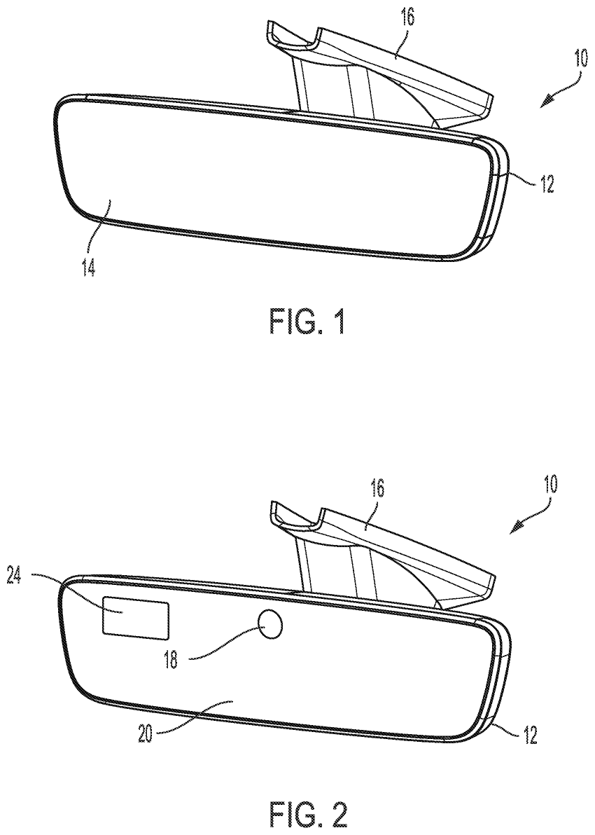

Referring now to the drawings and the illustrative embodiments depicted therein, an interior rearview mirror assembly 10 for a vehicle includes a casing 12 and a reflective element 14 positioned at a front portion of the casing 12 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly or stay 16. The system includes a camera 18 disposed at and movable with the mirror head. For example, the camera 18 may be disposed behind the mirror reflective element 14 and view through the mirror reflective element 14 for capturing image data representative of the interior cabin of the vehicle, including the driver's head region and occupant region of the vehicle cabin. The mirror reflective element 14 comprises a variable reflectance mirror reflective element that varies its reflectance responsive to electrical current applied to conductive coatings or layers of the reflective element.

The mirror assembly 10 includes or is associated with a driver monitoring system (DMS) and/or an occupant monitoring system (OMS), with the mirror assembly 10 comprising the driver/occupant monitoring camera 18 disposed at a back plate 20 (and optionally viewing through an aperture of the back plate) behind the reflective element 14 and viewing through the reflective element 14 toward at least a head region of the driver of the vehicle (FIG. 2). That is, the driver monitoring camera 18 is accommodated by the mirror head, and with the mounting structure 16 attached at the interior portion of the cabin of the vehicle, the driver monitoring camera views within the cabin of the vehicle toward at least the head region of the driver.

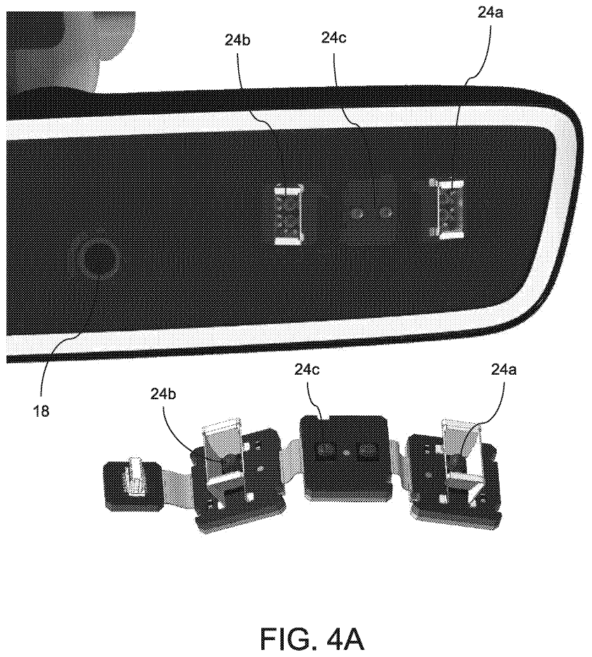

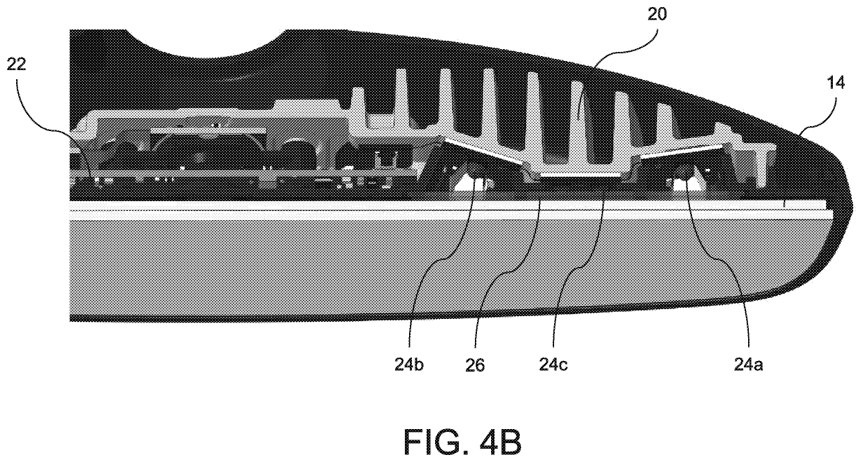

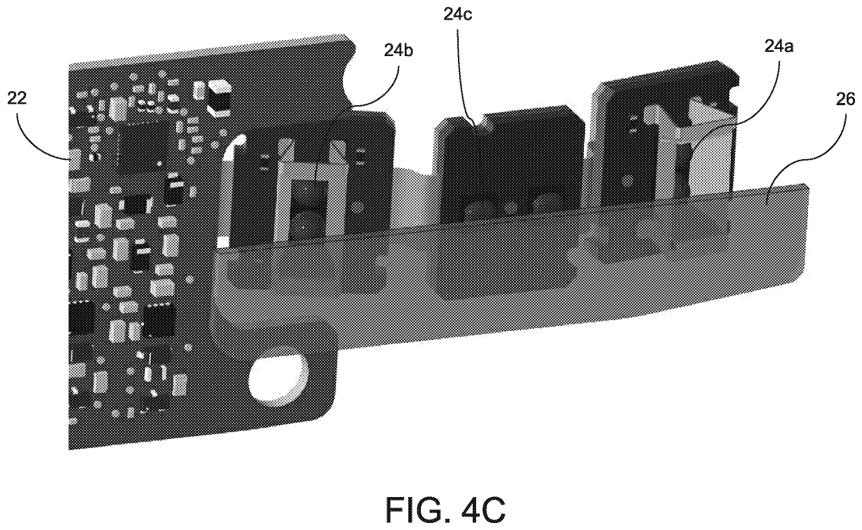

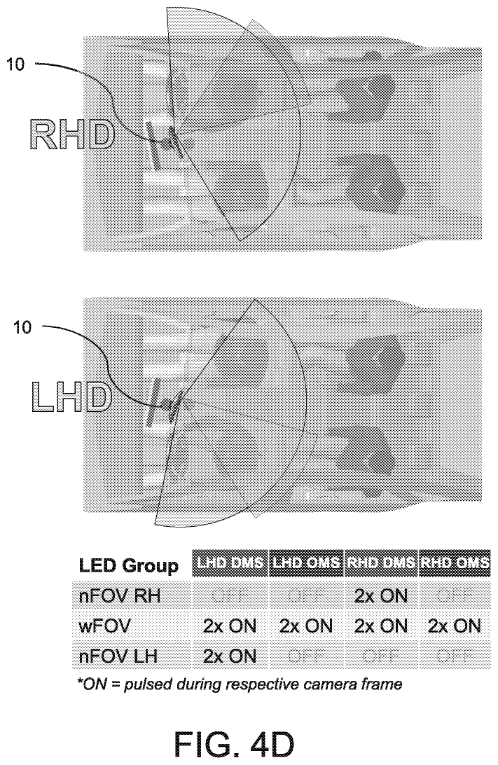

The mirror assembly 10 may include a printed circuit board (PCB) 22 (FIG. 4B) (such as disposed at the back plate) having a control or control unit comprising electronic circuitry (e.g., disposed at the circuit board or substrate in the mirror casing), which may include driver circuitry for controlling dimming of the mirror reflective element 14. The circuit board (or a separate DMS circuit board) includes a processor that processes image data captured by the camera 18 for monitoring the driver and determining, for example, driver attentiveness and/or driver drowsiness. The driver monitoring system includes the driver monitoring camera 18 and may also include an occupant monitoring camera (or the driver monitoring camera may have a sufficiently wide field of view so as to view the occupant or passenger seat of the vehicle as well as the driver region), and may provide occupant detection and/or monitoring functions as part of the OMS. The camera 18 may be disposed at the PCB 22, or the camera 18 may be disposed behind the PCB 22 and view through an aperture formed in the PCB 22 that is aligned with the aperture formed in the mirror back plate 20.

The DMS may include one or more non-visible light emitters or infrared (IR) or near infrared (NIR) light emitter(s) 24, which may be disposed at the back plate 20 and may emit light, when electrically powered to emit light, that passes through another aperture of the back plate 20 and through the reflective element 14 to illuminate the head region of the driver of the vehicle. For example, the mirror assembly 10 may include one or more IR or NIR light sources, such as light emitting diodes (LEDs) or vertical-cavity surface-emitting lasers (VCSEL) or the like, disposed at the back plate 20 behind the reflective element 14 and, when electrically powered to emit light, emitting near infrared light (or other nonvisible light) through the aperture of the back plate 20 and through the reflective element 14 toward the head region of the driver of the vehicle.

The interior rearview mirror 10 thus may include embedded cameras, IR/NIR illuminators and one or more processors for processing captured image data for the driver monitoring application. Optionally, the processor(s) may be disposed elsewhere in the vehicle, whereby the camera may be electrically connected to the processor via a suitable electrical connector, such as a coaxial cable. The inward facing camera 18 and light emitters 24 are fixed within the mirror head, and thus both components may be coupled with the mirror body. In these cases, the camera's field of view is subject to change from driver to driver as the mirror head is adjusted to set the driver's preferred rearward view provided by the mirror reflective element 14. Further, the field of view of the camera 18 and the regions of the interior cabin illuminated by the NIR light emitters 24 may change based on whether the mirror assembly 10 is installed in a left hand drive (LHD) vehicle (where the driver of the vehicle sits on a left hand side of the vehicle) or a right hand drive (RHD) vehicle (where the driver of the vehicle sits on a right hand side of the vehicle) as the mirror head may be at least partially tilted or canted toward a driver side of the vehicle and away from a passenger side of the vehicle.

Because the camera 18 moves with the mirror head, adjustment of the mirror head to set the driver's preferred rearward view changes the position and viewing direction or principal viewing axis of the camera 18 relative to the fixed base portion or mounting structure or stay 16, and thus relative to the vehicle. Put another way, the driver monitoring camera and the mirror reflective element move together and in tandem with the mirror head when the mirror head is adjusted about the mounting structure to provide a rearward view for the driver of the vehicle. Responsive to image processing of image data captured by the DMS camera, DMS algorithms may calculate or determine the driver eye gaze direction relative to the camera 18, and thus relative to the mirror head. Precise eye gaze direction analysis is important to understanding what part of the vehicle cabin the driver is looking at. This information allows the advanced driver or driving assistance systems (ADAS) of the vehicle to generate an alert or intervene appropriately when the user may be distracted and/or when the user is looking off the road (i.e., not looking ahead of where the vehicle is traveling along the road). Further, the OMS may process image data captured by the camera at the mirror head to determine presence of passengers within the vehicle and/or presence of objects within the vehicle, such as within the footwells of the vehicle.

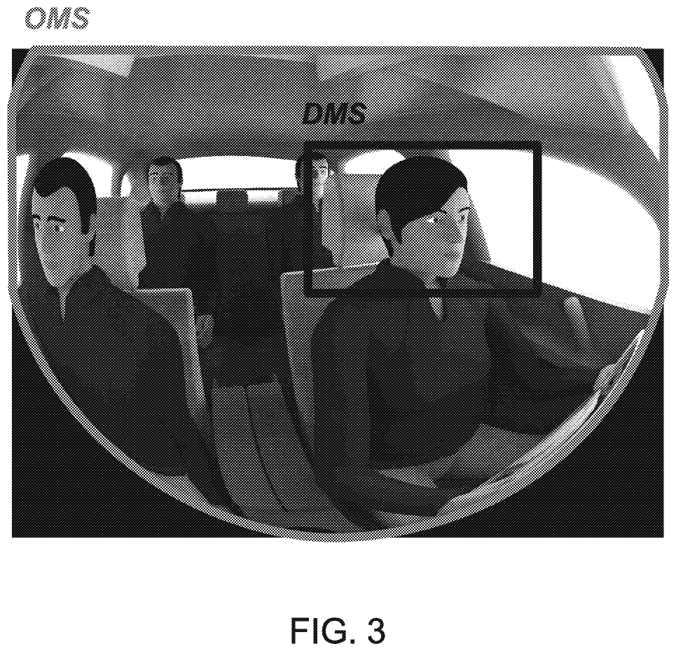

As shown in FIG. 3, the DMS may process at least a portion of the image data captured by the camera 18 (e.g., at least a portion of the frames of image data captured) to view a driver's head region of the interior cabin of the vehicle. The DMS may have a maximum power requirement, such as an ambient rejection ratio of greater than or equal to about 0.05 (e.g., about 13 W/m² at the driver's head region) and a minimum pulse/exposure time of about 0.5 msec. This may be required for drivers wearing glasses during sunny conditions. The DMS may have a maximum energy requirement, such as a signal to noise ratio (SNR) greater than or equal to about 33.4 db (with no additional gain) and a maximum pulse/exposure time of about 4 msec. The OMS may process a greater portion of the image data captured by the camera 18 (e.g., the full frame of image data captured) to view one or more passenger sitting regions within the interior cabin of the vehicle. The OMS may not have a maximum power requirement, and the OMS may have a maximum energy requirement, such as a SNR greater than or equal to about 20 db (with gain) and a maximum pulse/exposure time of about 4 msec.

In some examples, and such as shown in FIGS. 4A-4C, the NIR light emitters 24 include one or more first or RHD near field of view (nFOV) light emitters 24a configured to emit light toward the driver side of a RHD vehicle, one or more second or LHD nFOV light emitters 24b configured to emit light toward the driver side of a LHD vehicle, and one or more wide field of view (wFOV) light emitters 24c configured to emit light toward both the driver and passenger sides of the vehicle cabin. The light emitters 24 are disposed at the mirror back plate 20 and the RHD nFOV light emitters 24a and the LHD nFOV light emitters 24b are angled or titled or angled toward respective sides of the mirror head to accommodate the installation of the mirror assembly in both LHD vehicles and RHD vehicles. In other words, a mounting plane of the light emitters 24 may be angled or tilted or biased relative to a plane of the mirror reflective element 14 so that, with the mirror set to provide the rearward field of view for the driver, the light emitters 24 may be at least partially biased toward one side of the vehicle and provide greater illumination at that side. Thus, the principal axis of light emitted from the light emitters 24 may pass through the mirror reflective element at non-perpendicular angles.

In the illustrated example, the light emitters 24 are disposed at respective circuit elements that are attached at the mirror back plate 20 and angled relative to one another and relative to the mirror reflective element 14 (FIG. 4A). For example, the RHD nFOV light emitters 24a may be tilted or angled or biased about 10 degrees toward the right hand side of the vehicle cabin and the LHD nFOV light emitters 24b may be tilted or angled or biased about 22 degrees toward the left hand side of the vehicle cabin. The wFOV light emitters 24c may not be biased toward either side of the vehicle cabin. The circuit elements may be electrically connected to one another and to the main PCB 22 via flexible connectors or ribbon connectors.

Further, the RHD nFOV light emitters 24a and the LHD nFOV light emitters 24b may include or be associated with surface mount reflectors (SMRs) (e.g., attached at the respective circuit element of the light emitter) for directing the light toward the driver region of the interior cabin of the vehicle. A red glow filter 26 may be disposed in front of the light emitters 24 such that NIR light emitted by the light emitters 24 passes through the red glow filter 26 to illuminate the interior cabin of the vehicle (FIGS. 4B and 4C).

As shown in FIG. 4D, when disposed in a RHD vehicle, the mirror head may be tilted or angled at least partially toward the driver side of the vehicle at the right hand side of the vehicle. Similarly, when disposed in a LHD vehicle, the mirror head may be tilted or angled at least partially toward the driver side of the vehicle at the left hand side of the vehicle. Thus, when operated to capture image data for the DMS of the RHD vehicle, the RHD nFOV light emitters 24a and the wFOV light emitters 24c may be operated to illuminate portions of the interior cabin of the vehicle. When operated to capture image data for the DMS of the LHD vehicle, the LHD nFOV light emitters 24b and the wFOV light emitters 24c may be operated to illuminate portions of the interior cabin of the vehicle. When operated to capture image data for the OMS of the RHD vehicle or the LHD vehicle, only the wFOV light emitters 24c may be operated.

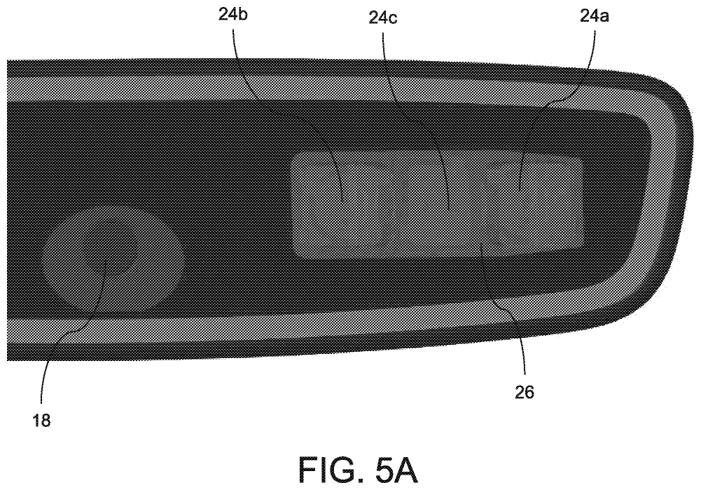

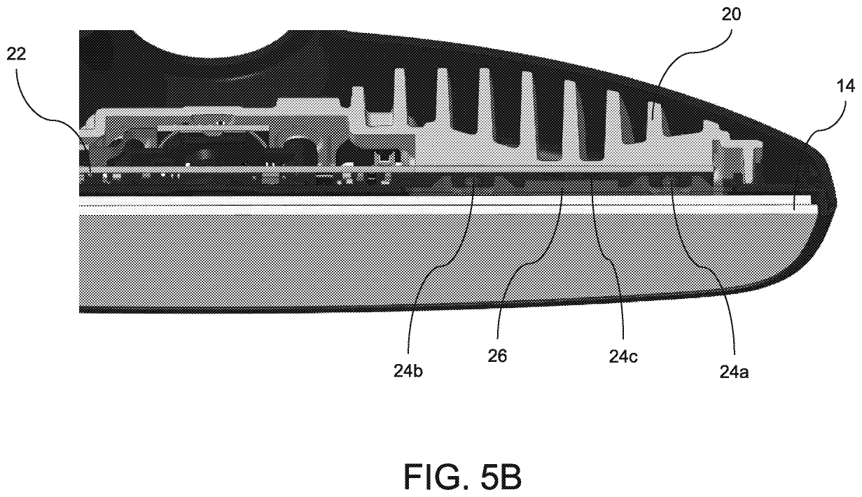

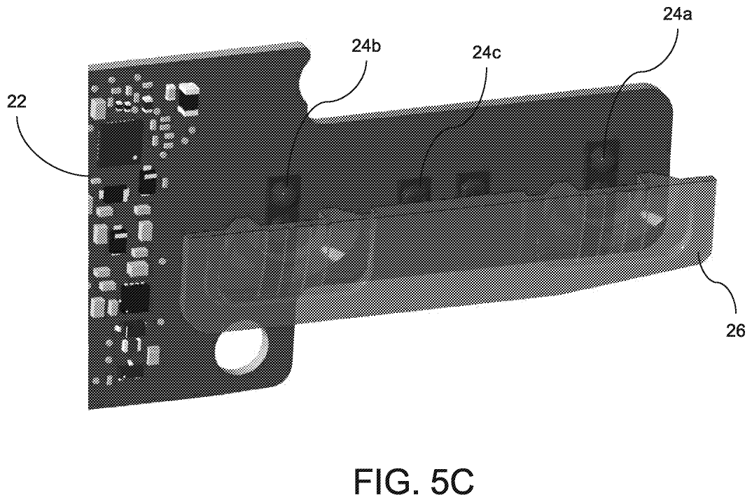

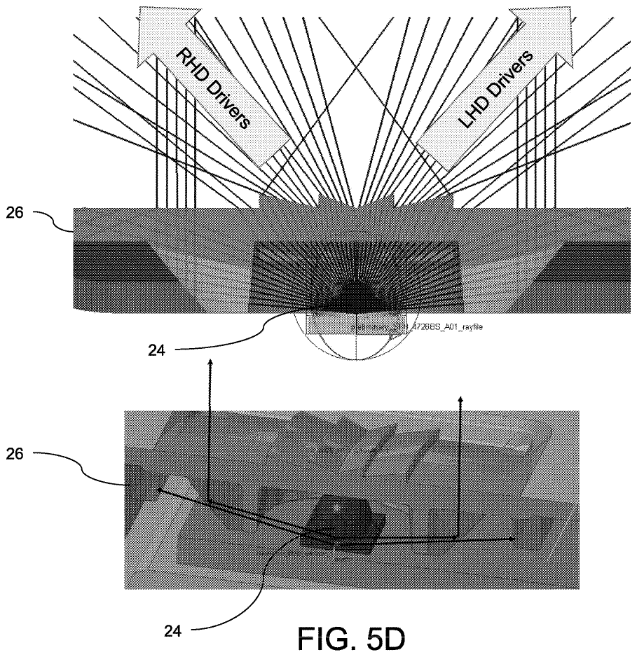

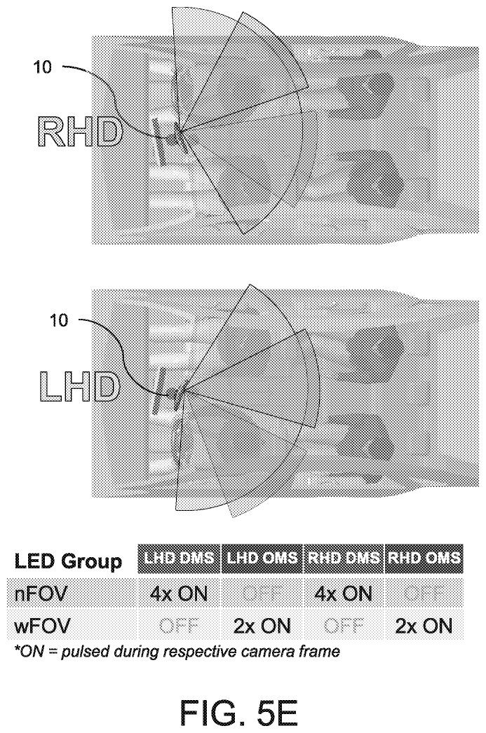

Referring to FIGS. 5A-5E, to improve NIR illumination of the vehicle cabin and reduce materials cost and complexity, the NIR light emitters 24 may be disposed at a portion of the main PCB 22 and the red glow filter 26 may include lens or optic portions that direct or bend or refract light toward the respective RHD driver's region and the LHD driver's region. That is, the mounting planes of the NIR light emitters 24 may be parallel to or coplanar with the main PCB 22 and the mirror reflective element 14 and the red glow filter 26 disposed between the NIR light emitters 24 and the mirror reflective element 14 may cause NIR light that passes through the red glow filter 26 to pass through the mirror reflective element 14 at oblique angles relative to the mirror reflective element 14. This may cause the first nFOV light emitters 24a to emit light that is directed at least toward the RHD driver's region and the second nFOV light emitters 24b to emit light that is directed at least toward the LHD driver's region despite the first nFOV light emitters 24a and the second nFOV light emitters 24b being mounted parallel or coplanar with one another (FIGS. 5B and 5C).

Put another way, with the NIR light emitters 24 disposed at the main PCB 22 that is parallel to the inner or rear side of the mirror reflective element, the NIR light sources of the NIR light emitters 24 emit NIR light along a principal beam axis generally normal or perpendicular to the main PCB 22 and the rear side of the mirror reflective element. By passing through the red glow filter, the NIR light is directed or refracted or angled at least partially toward the driver side of the vehicle and passes through the mirror reflective element at an oblique angle. Thus, the NIR light emitters 24 emit light at a first beam angle (e.g., perpendicular to the main PCB) and the light passes through the red glow filter 26 and exits the mirror reflective element at a second beam angle (e.g., an oblique angle) that is more toward the driver side of the vehicle than the first beam angle.

The light emitters 24 may be disposed at an extension or side portion of the PCB 22 that is attached at the mirror back plate 20. In the illustrated example of FIG. 5C, the light emitters 24 are disposed at a side portion of the PCB 22 closest to the right hand side of the cabin of the vehicle, with the first or RHD nFOV light emitters 24a disposed furthest outboard at the side portion (e.g., to be closest to the right hand side of a RHD vehicle), the second or LHD nFOV light emitters 24a disposed closest to a central portion of the PCB 22 (e.g., to be closest to the left hand side of a LHD vehicle), and the wFOV light emitters 24c are disposed between the first nFOV light emitters 24a and the second nFOV light emitters 24b. A heat sink portion of the mirror back plate 20 having a plurality of heat dissipating fins may correspond to the mounting position of the light emitters 24 to draw heat away from the light emitters 24 during operation.

At least a portion of the red glow filter 26 may be attached at the PCB 22 and substantially surround or circumscribe the light emitters 24. The red glow filter 26 may include contours and lenses that correspond to the light emitters and cause light emitted by the light emitters 24 to be redirected or refracted toward the portions of the interior cabin. The red glow filter 26 may comprise a thermoplastic material with a dye that at least partially blocks visible light incident thereat (e.g., light with wavelengths between about 200 nm to about 830 nm) and that at least partially transmits NIR light or IR light (e.g., light with wavelengths between about 800 nm to about 1,000 nm). For example, the red glow filter may include EPOLIGHT™ 7276A dye or 7276F dye commercially available from Epolin of Newark, NJ. In some examples, the red glow filter 26 may be attached to or integrally formed with a portion of the mirror reflective element 14 (e.g., a rear glass substrate of the mirror reflective element).

Moreover, when the light emitters 24 are operated, the red glow filter 26 may direct a majority of the light toward the sides of the interior cabin with very little light directed normal to the PCB 22 (FIG. 5D). That is, with the mirror assembly mounted in either a LHD vehicle or a RHD vehicle, both the first nFOV light emitters 24a and the second nFOV light emitters 24b may be operated during driver monitoring as both light emitters 24 may illuminate at least a portion of the driver region of the vehicle cabin (FIG. 5E). For example, when operated to capture image data for the DMS of the RHD vehicle, the first nFOV light emitters 24a and the second nFOV light emitters 24b may both be operated. The first nFOV light emitters 24a and the second nFOV light emitters 24b may also both be operated during capture of image data for the DMS of the LHD vehicle. When operated to capture image data for the OMS of the RHD vehicle or the LHD vehicle, only the wFOV light emitters 24c may be operated. The light emitters 24 and red glow filter 26 with optics may increase the intensity of the IR LEDs, such as by 20 percent or more.

Mounting the NIR light emitters 24 to the main PCB 22 with the modified red glow filter directing light toward sides of the interior cabin of the vehicle may result in improved illumination of the interior cabin and reduced parts cost and complexity. For example, the NIR light emitters 24 do not need to be mounted to separate circuit elements connected to each other and/or the main PCB via various connectors and the light emitters 24 do not require SMRs. Further, assembling the mirror assembly with NIR light emitters disposed on separate circuit elements may comprise a difficult and costly process, whereas the main PCB 22 and light emitters 24 may be installed in the mirror head during the same installation step.

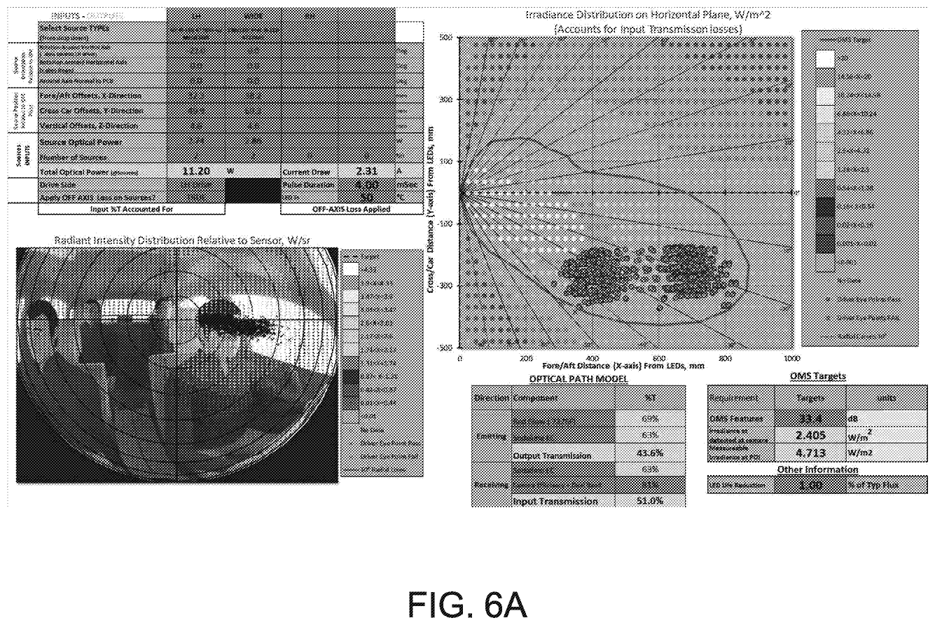

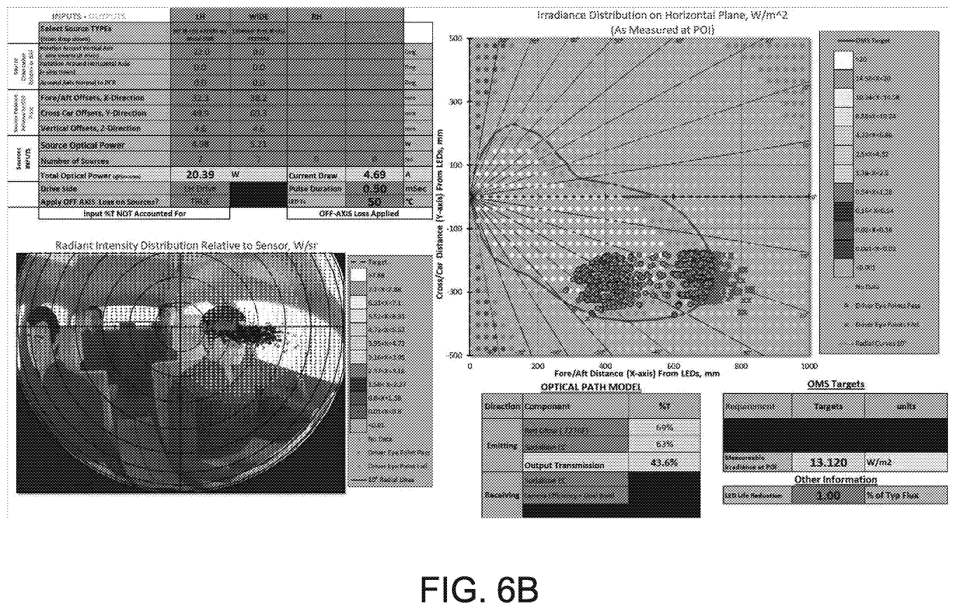

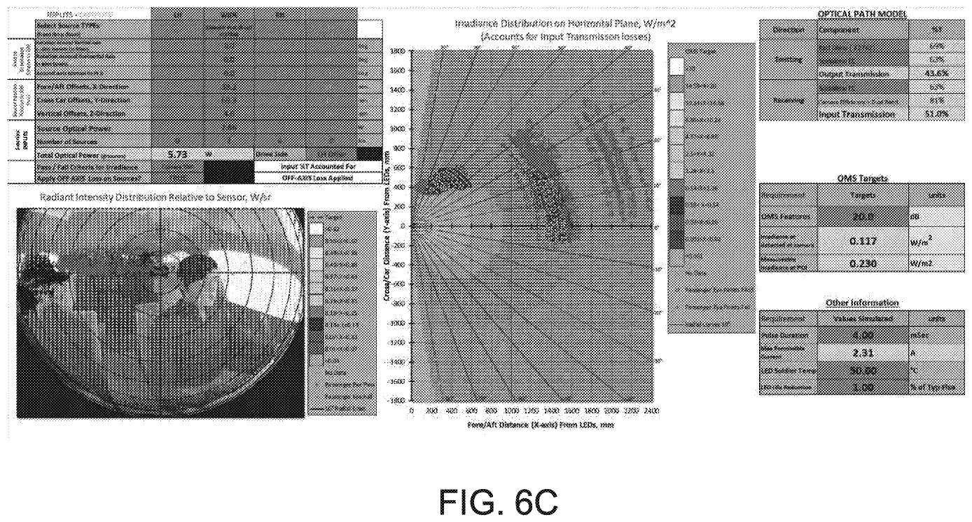

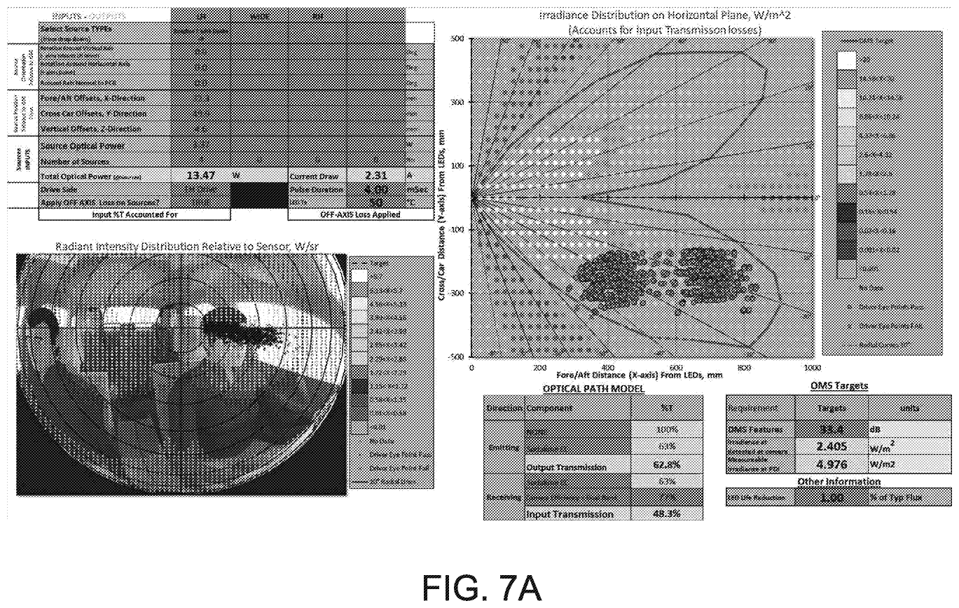

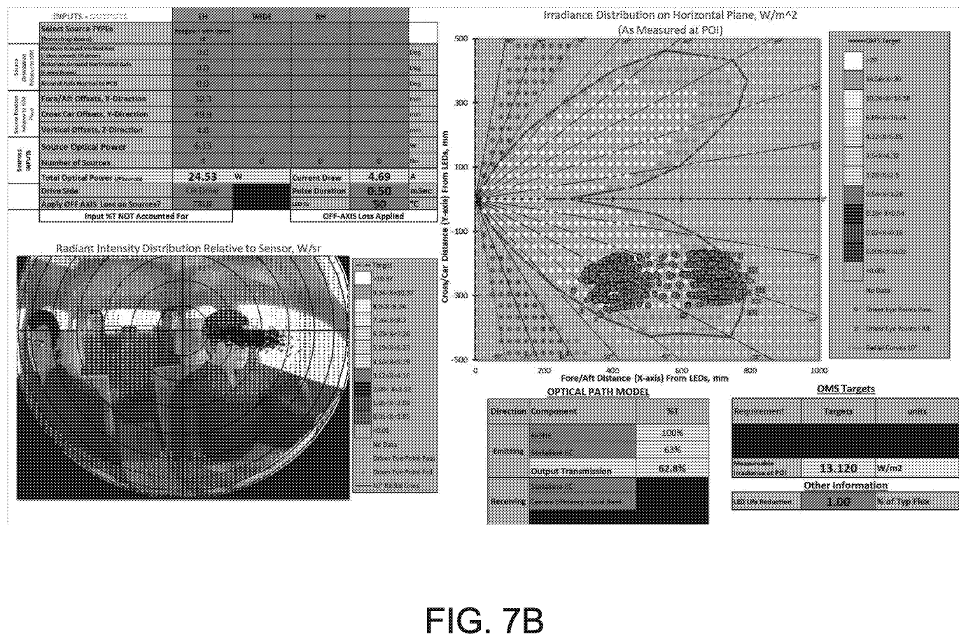

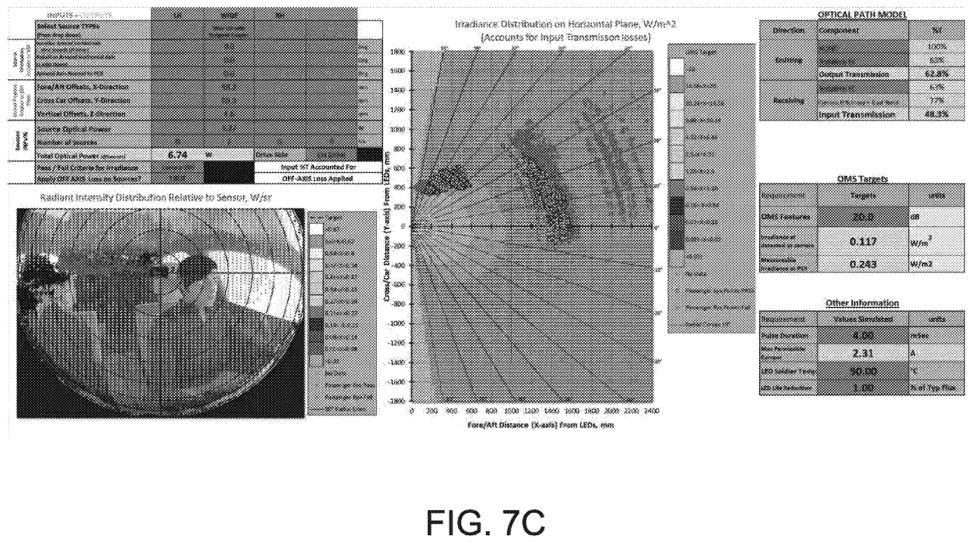

FIGS. 6A-6C illustrate example irradiance results of the NIR light emitters of FIGS. 4A-4D and FIGS. 7A-7C illustrate example irradiance results of the NIR light emitters of FIGS. 5A-5E. As shown, the NIR light emitters mounted to the main PCB 22 drive greater optical power and/or provide greater irradiance for the same current draw as compared to the NIR light emitters disposed at separate circuit elements. For example, under maximum energy conditions during driver monitoring, the NIR light emitters of FIGS. 4A-4D may provide total optical power of 11.2 Watts at a current draw of 2.31 Amps with measured irradiance at the driver's head region of 4.713 W/m² (FIG. 6A) and the NIR light emitters of FIGS. 5A-5E may provide a total optical power of 13.47 Watts at a current draw of 2.31 Amps with a measured irradiance at the driver's head region of 4.976 W/m² (FIG. 7A). Under maximum power conditions during driver monitoring, the NIR light emitters of FIGS. 4A-4D may provide total optical power of 20.39 Watts at a current draw of 4.69 Amps with measured irradiance at the driver's head region of 13.12 W/m² (FIG. 6B) and the NIR light emitters of FIGS. 5A-5E may provide a total optical power of 24.53 Watts at a current draw of 4.69 Amps with a measured irradiance at the driver's head region of 13.12 W/m² (FIG. 7B). Under maximum energy conditions during occupant monitoring, the NIR light emitters of FIGS. 4A-4D may provide total optical power of 5.73 Watts at a current draw of 2.31 Amps with measured irradiance at a passenger region of 0.23 W/m² and measured irradiance at the camera of 0.117 W/m² (FIG. 6C) and the NIR light emitters of FIGS. 5A-5E may provide a total optical power of 6.74 Watts at a current draw of 2.31 Amps with a measured irradiance at the passenger region of 0.243 W/m² and measured irradiance at the camera of 0.117 W/m² (FIG. 7C).

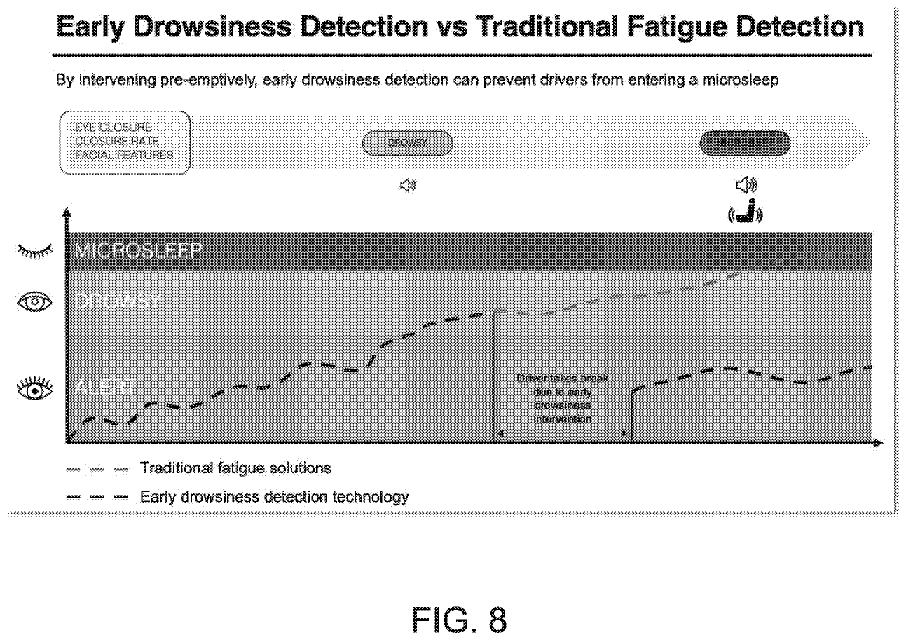

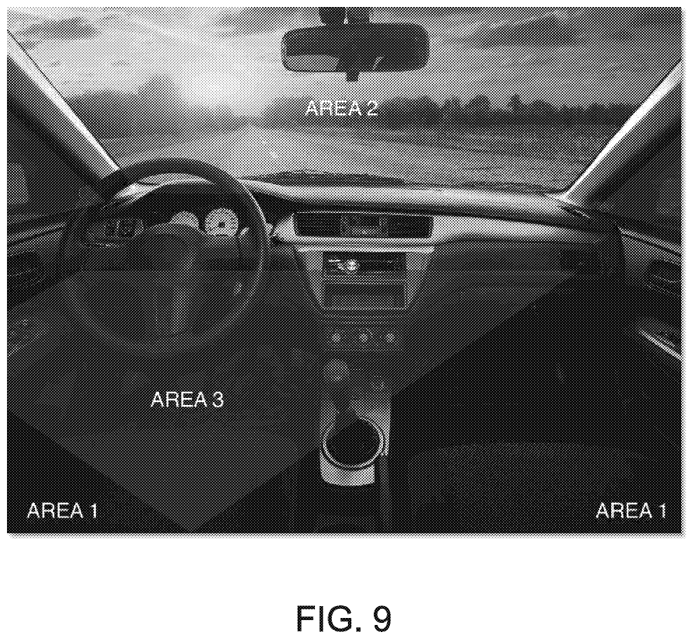

Referring to FIGS. 8 and 9, to satisfy and/or exceed regulatory requirements, the DMS may process captured image data to determine gaze direction for the driver, determine a head pose of the driver, determine a long/short distraction of the driver, determine phone or mobile device use by the driver, determine that the driver is smoking, perform drowsiness or microsleep detection for the driver, determine that the driver is speaking, laughing or yawning, perform driver recognition, and the like. The DMS may determine that the driver's gaze direction is at or toward the road in front of the vehicle, at or toward the instrument panel or gauge cluster, at or toward the radio or infotainment system of the vehicle, at or toward the side mirrors of the vehicle, at or toward the side windows of the vehicle, and the like. Further, the OMS may process captured image data to perform passenger detection, to determine passenger and/or driver seat belt use, and for determining a camera pose adjustment. The camera 18 may provide RGB video streaming.

This may allow the DMS to provide DDAW capabilities, where the system provides a visual, audible and/or haptic alert based on eye movements and head position of the driver. This may be according to a drowsiness threshold aligned to a scientific measure of sleepiness, such as the Karolinska Sleepiness Scale (FIG. 8). Further, the DMS may provide ADDW capabilities, where the system provides a visual warning incorporated with an acoustic and/or haptic warning based on the driver gaze downward or toward the infotainment system of the vehicle (e.g., Area 3 in FIG. 9) or based on the driver gaze toward the passenger region of the vehicle (e.g., Area 1 in FIG. 9). This may be based on vehicle speed and gaze duration, where the threshold for providing the alert may be set such that the alert is provided after 6 or more seconds of looking away from the road (e.g., Area 2 in FIG. 9) when the vehicle is travelling at 20 km/h or more and after 3.5 or more seconds of looking away when the vehicle is travelling at 50 km/h or more.

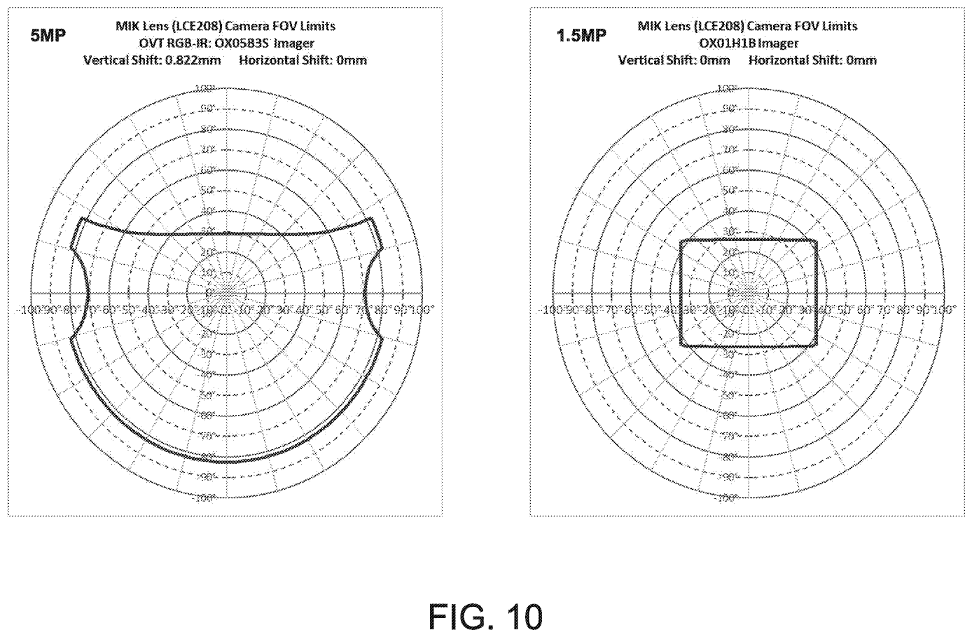

As shown in FIG. 10, the field of view and resolution of the camera 18 must be sufficient to satisfy increased processing requirements of the DMS and OMS. For example, the camera on the left in FIG. 10 may have a resolution of 5 megapixels with a horizontal field of view of about 142 degrees and a vertical field of view of about 112 degrees and the camera on the right may have a resolution of 1.5 megapixels with a horizontal field of view of about 69.3 degrees and a vertical field of view of about 52.7 degrees. Although the camera on the right has a smaller resolution and field of view, it may capture image data sufficient for the increased requirements of at least the DMS, and thus allow for use of a camera with lower parts cost.

That is, the camera may view at least the driver's head region, allowing for reduced field of view and reduced resolution. This results in reduced gaze areas and thus reduced required accuracy for camera pose and gaze direction determinations. Moreover, the camera may capture image data representative of IR light or NIR light and not capture image data of visible light as ARR is not a concern. Moreover, when positioned behind a prismatic mirror reflective element, the mirror may provide higher transmission of light through the glass.

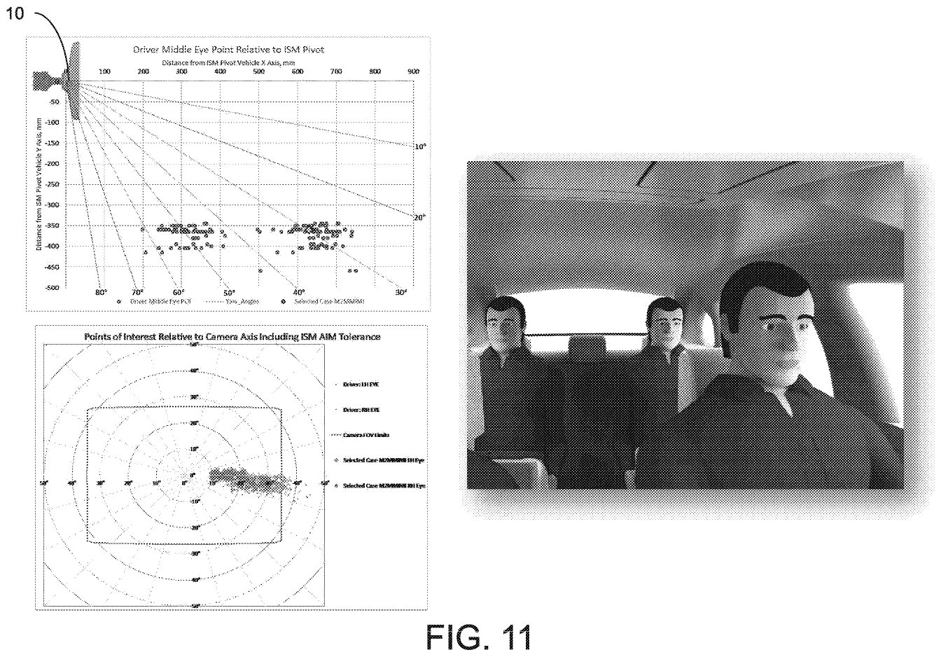

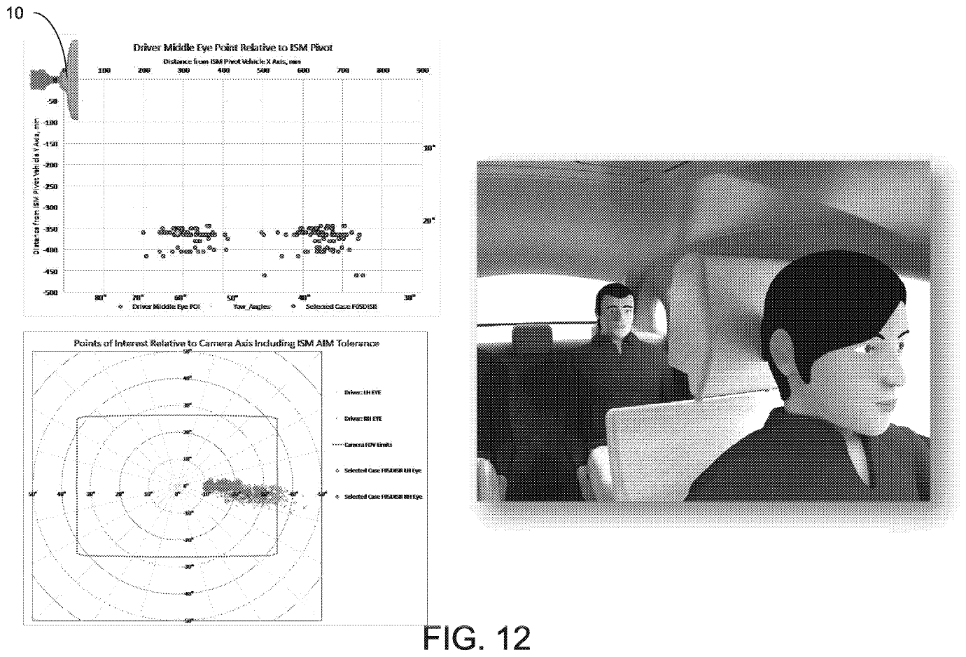

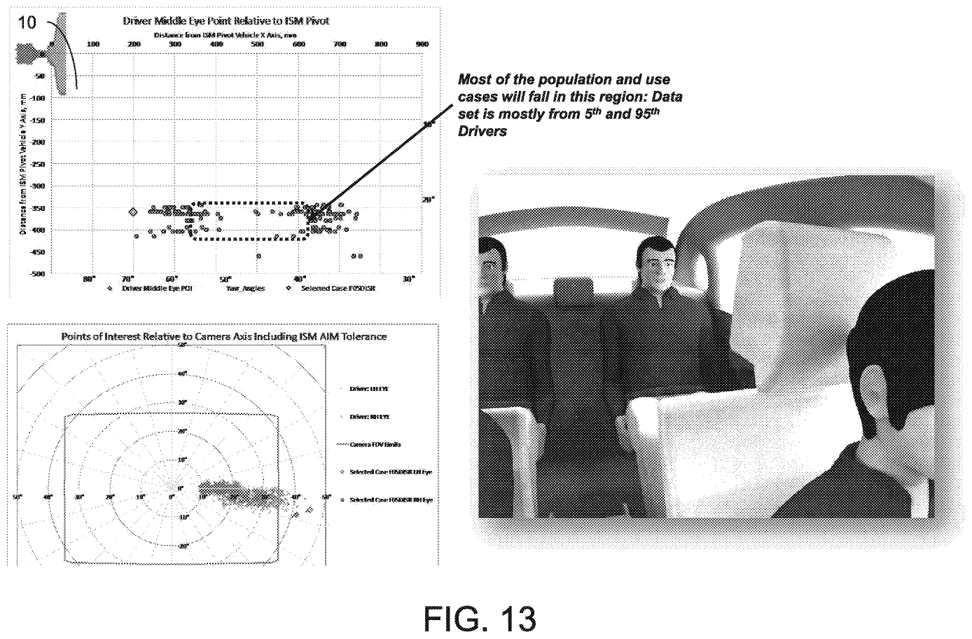

For the camera with the smaller field of view, FIG. 11 shows example frames of image data and detected eye position for a male driver with a size in the 95th percentile and FIG. 12 shows example frames of image data and detected eye position for a female driver with a size in the 5th percentile. As shown, the camera is able to view both eyes of the larger and smaller drivers and thus may capture suitable image data for the DMS providing DDAW and ADDW capabilities. FIG. 13 shows example frames of image data and detected eye positions for a female driver with a size below the 5th percentile.

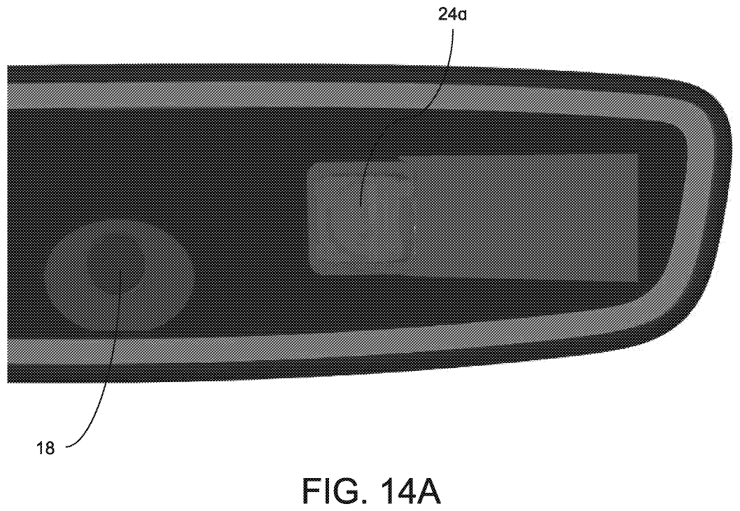

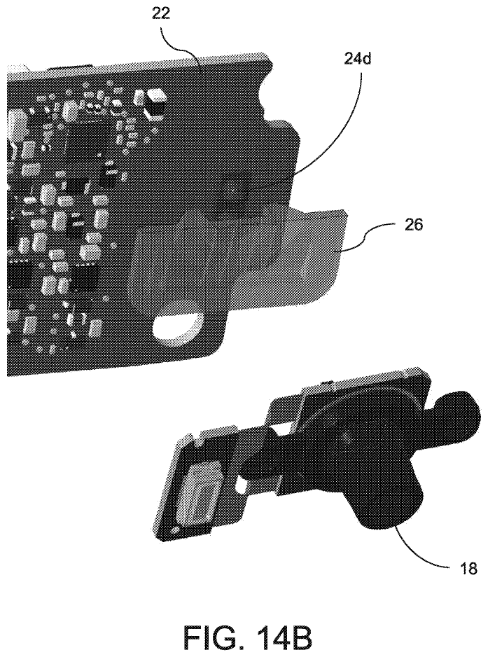

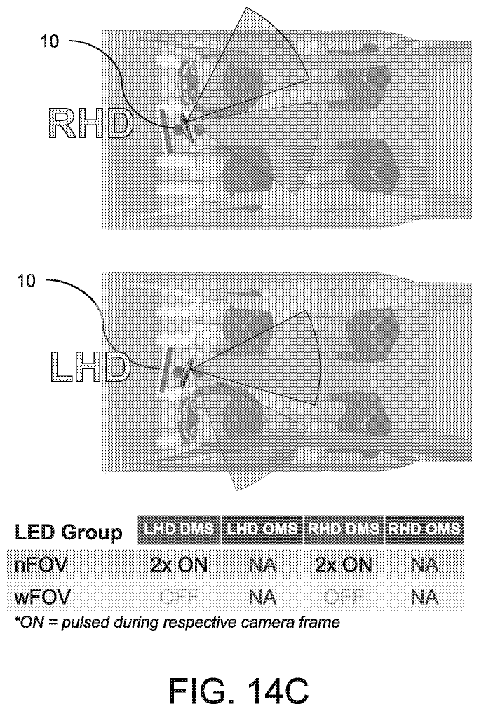

With the camera viewing only the driver region of the interior cabin of the vehicle, the NIR light emitters 24 may be configured to provide illumination for the driver regions of RHD vehicles and LHD vehicles and not configured to provide illumination for occupant monitoring. As shown in FIGS. 14A-14C, the mirror head may accommodate driver monitoring nFOV light emitters 24d (e.g., two NIR LEDs) configured to direct light toward both sides of the vehicle. For example, the nFOV light emitters 24d may be disposed at the main PCB 22 and the red glow filter 26 may include an optic or lens portion that directs or refracts light toward the driver side and toward the passenger side of the vehicle (FIGS. 14B and 14C). Thus, when operated to provide driver monitoring for a LHD vehicle or a RHD vehicle, the nFOV light emitters 24d are operated and provide illumination directed toward the passenger side and toward the driver side of the vehicle.

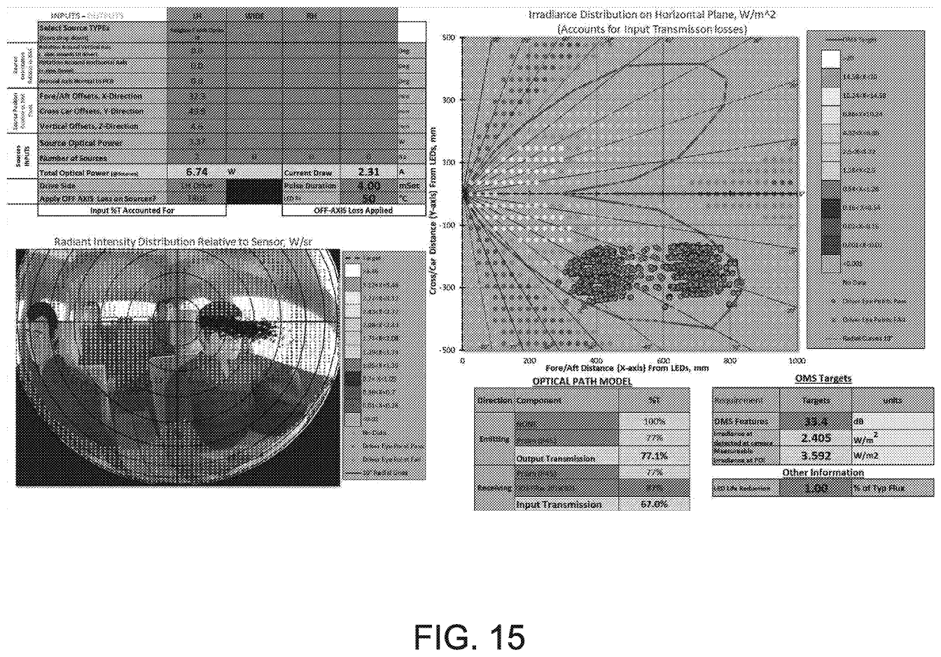

As shown in FIG. 15, this may provide sufficient irradiance of the driver's head region. Because the NIR system only uses a band pass filter (which has a higher transmittance of NIR light than a dual band pass filter) and because the mirror may have a prismatic mirror reflective element (which may have a higher transmittance of NIR light that an electrochromic mirror reflective element), a higher percentage of NIR light emitted by the nFOV light emitters 24d may pass through the mirror reflective element to be captured by the camera 18. For example, up to 52 percent or more of NIR light emitted may be captured by the camera 18.

Because the nFOV light emitters 24d are disposed at the main PCB 22 and because the camera 18 has a reduced field of view and reduced resolution, significant cost and assembly savings may be realized. Thus, the system may provide a low-cost entry level DMS solution with low integration costs for the vehicle manufacturer. This may lead to a greater portion of vehicles being equipped with DMS and/or OMS capable interior mirror assemblies. Further, there may be additional LED driver savings with a reduced number of NIR LEDS.

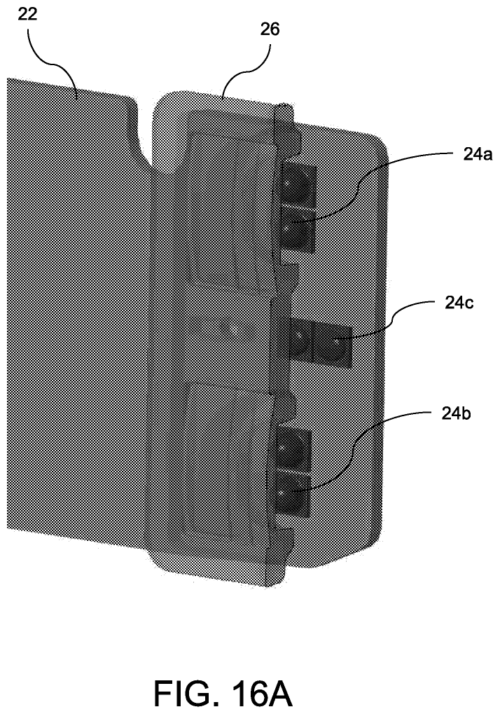

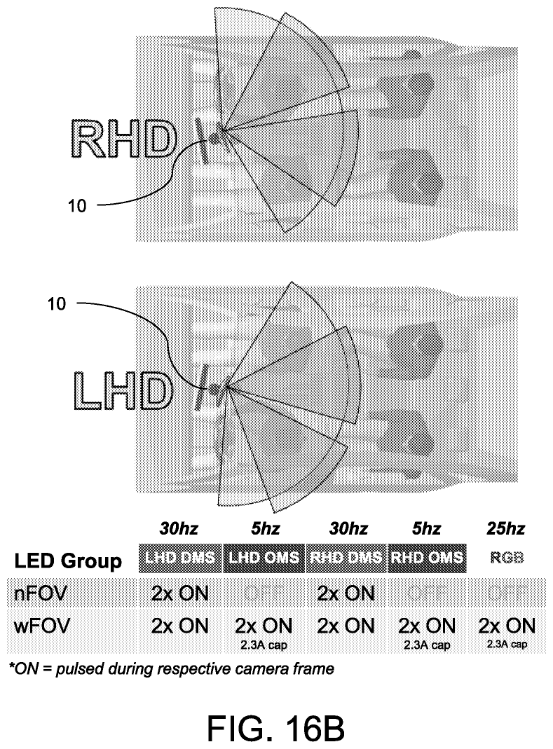

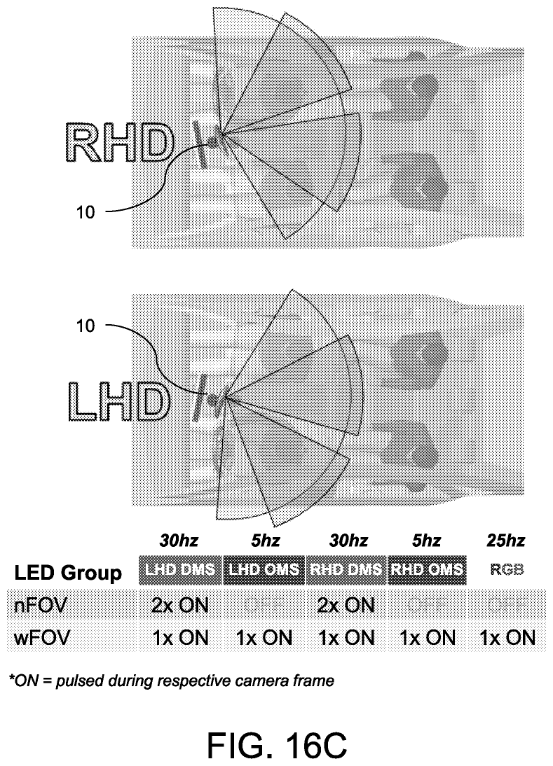

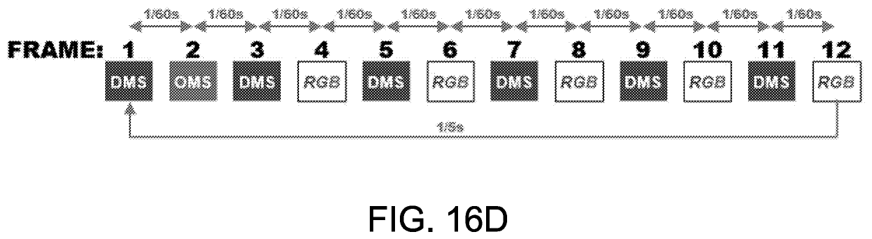

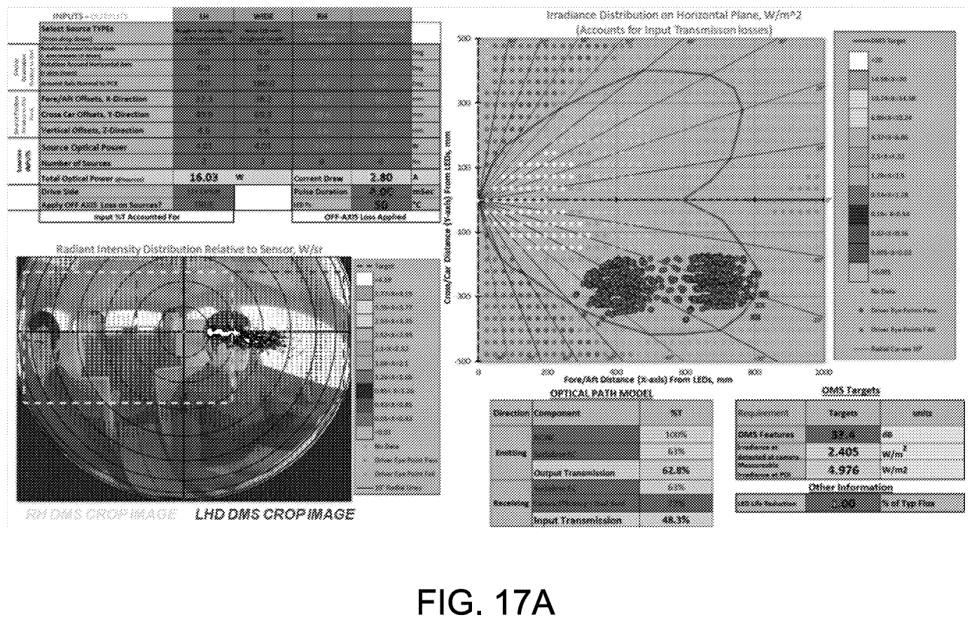

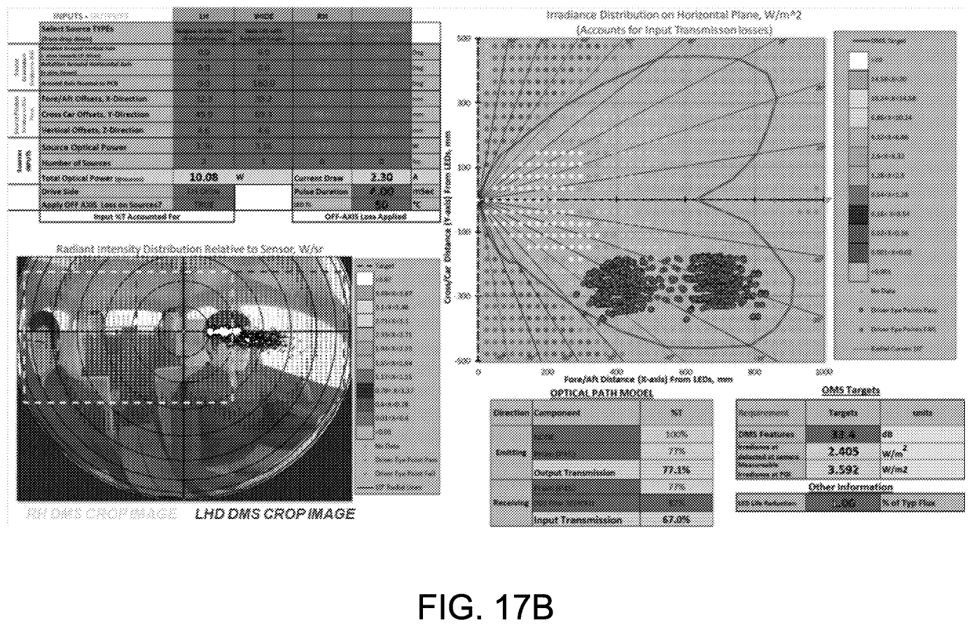

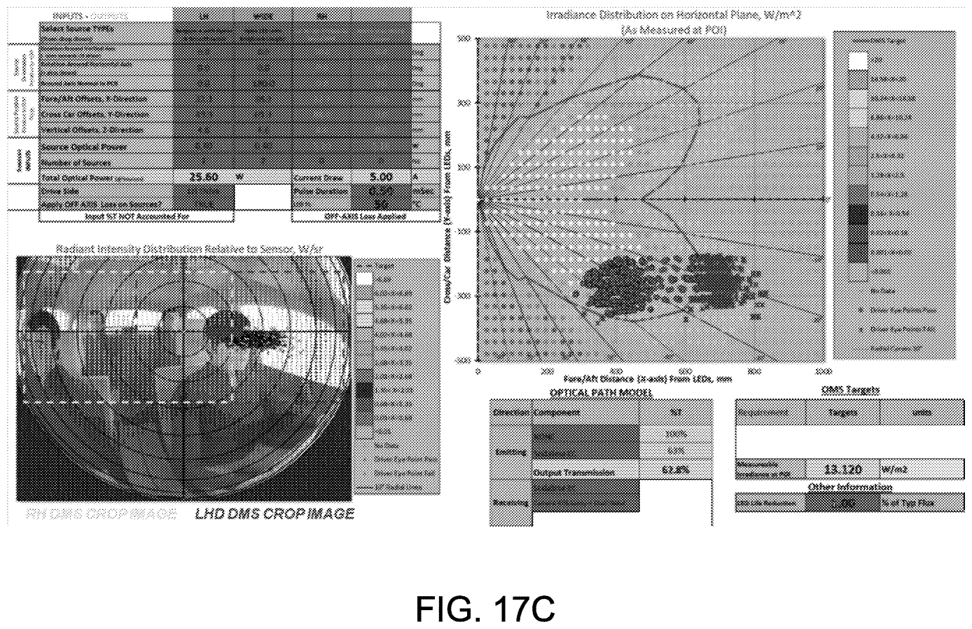

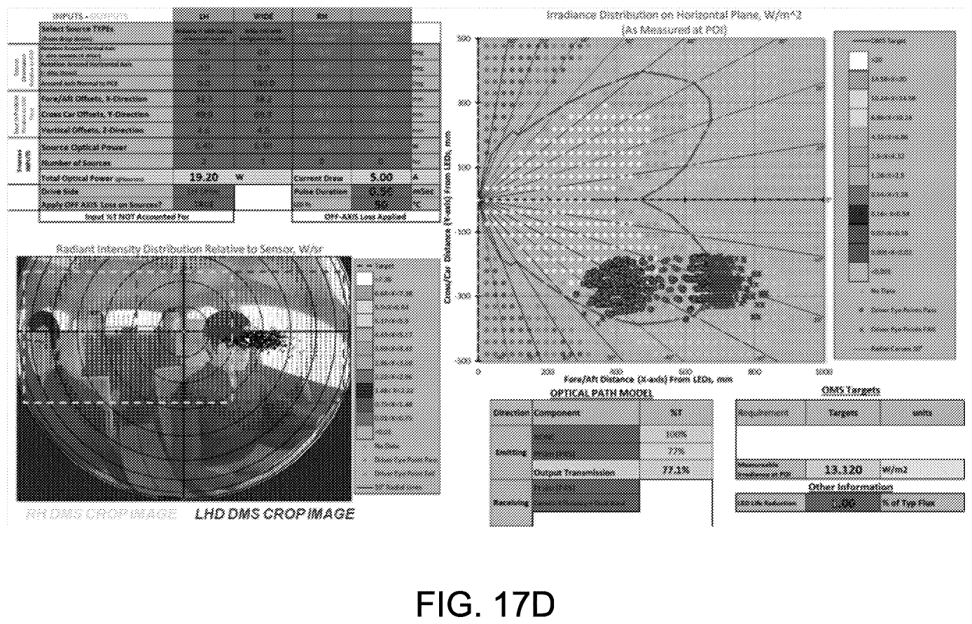

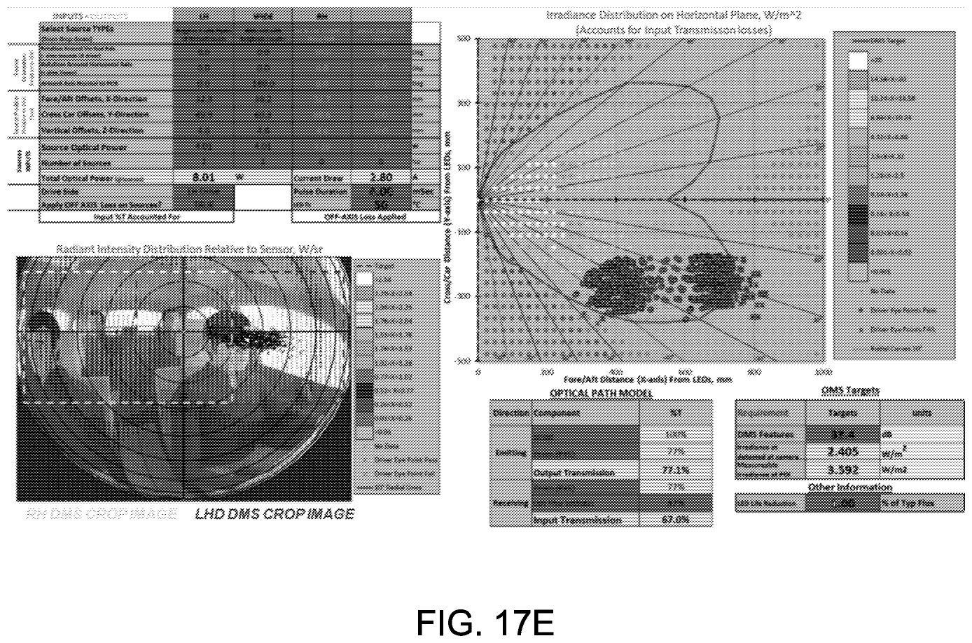

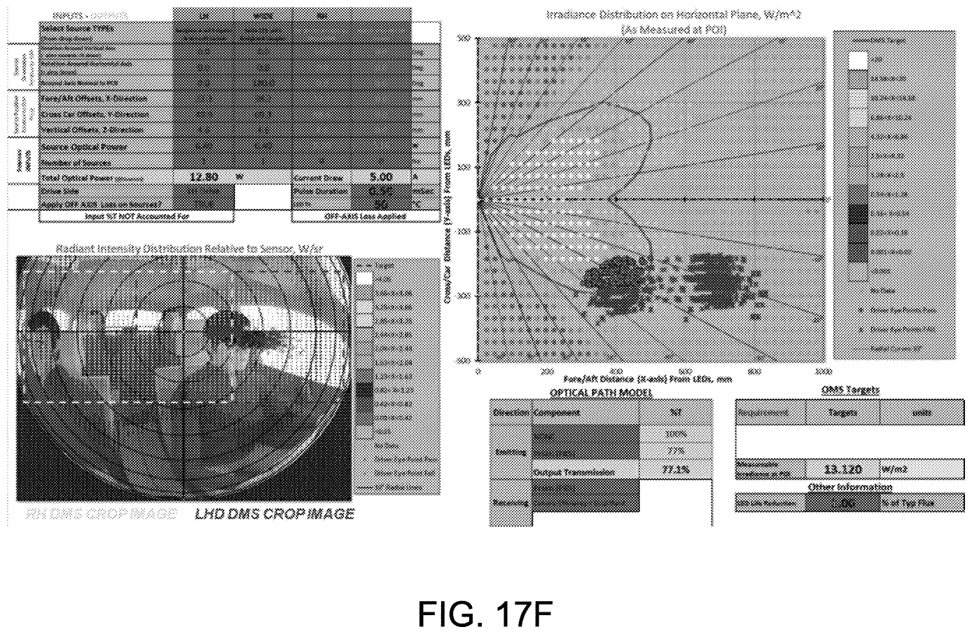

Referring to FIGS. 16A-17F, the NIR light emitters 24 may be disposed at the side portion of the PCB 22 and vertically stacked relative to one another. That is, the NIR light emitters 24 may be disposed at the side portion of the PCB 22, such that the individual NIR light emitters 24 are at substantially equal lateral positions along the PCB 22 and above or below one another. For example, the first or RHD nFOV light emitters 24a may be disposed at an upper region of the side portion of the PCB 22, the second or LHD nFOV light emitters 24b may be disposed at a lower region of the side portion of the PCB 22, and the wFOV light emitters 24c may be disposed between the first nFOV light emitters 24a and the second nFOV light emitters 24b. In other examples, the second nFOV light emitters 24b may be disposed at the upper region of the side portion of the PCB 22 and the first nFOV light emitters 24a may be disposed at the lower region of the side portion of the PCB 22. In the illustrated example of FIG. 16A, the first nFOV light emitters 24a and the second nFOV light emitters 24b each include two NIR LEDs (and may optionally include one or more LEDs, such as four or more LEDs and the like) and the wFOV light emitters 24c include two NIR LEDs (and may optionally include one or more LEDs, such as four or more LEDs and the like). The PCB 22 may be slightly larger to accommodate the light emitters, such as having an increased height (e.g., perpendicular to a longitudinal axis of the mirror head). Further, the red glow filter 26 may be vertically oriented to correspond to the positions of the light emitters 24, with the red glow filter 26 including optic elements configured to direct or refract light emitted by the light emitters 24 toward desired portions of the interior cabin of the vehicle.

Because the red glow filter 26 may direct light emitted by the light emitters 24 toward the left hand side and the right hand side of the vehicle, both the first nFOV light emitters 24a and the second nFOV light emitters 24b may be operated during driver monitoring for LHD and RHD vehicles. As shown in FIG. 16B, with the mirror assembly 10 having an electrochromic mirror reflective element, both the first nFOV light emitters 24a and the second nFOV light emitters 24b, as well as two LEDs of the wFOV light emitters 24c may be operated during capture of image data for driver monitoring in LHD and RHD vehicles. That is, the light emitters 24, when operated, emit light that passes through the electrochromic mirror reflective element to illuminate regions of the interior cabin of the vehicle. In particular, the LEDs may be pulsed on during capture of frames of image data at a rate of 30 Hertz. During capture of image data for occupant monitoring in LHD and RHD vehicles, the nFOV light emitters 24a, 24b may not be operated and the two LEDs of the wFOV light emitters 24c may be operated. That is, the LEDs may be pulsed on during capture of frames of image data at a rate of five Hertz. Further, during capture of image data representative of visible light (e.g., RGB image data), such as for controlling dimming of the electrochromic reflective element or for supplementing driver monitoring and/or occupant monitoring, the nFOV light emitters 24a, 24b may not be operated and the two LEDs of the wFOV light emitters 24c may be operated, such as pulsed on during capture of frames of image data at a rate of 25 Hertz.

Thus, the first nFOV light emitters 24a and the second nFOV light emitters 24b may each include two or more NIR LEDs that are not biased toward one side of the vehicle and emit light generally normal to the plane of the PCB 22. The nFOV light emitters 24a, 24b may have a current draw of about 2.8 Amps at a pulse of about 4 milliseconds. Similarly, the wFOV light emitters 24c include two or more NIR LEDs that are not biased toward one side of the vehicle and thus emit light generally normal to the plane of the PCB 22. The wFOV light emitters 24c may have a current draw of about 2.8 Amps at a pulse of about 4 milliseconds and may operate at a 2.3 Amp cap, such as due to a current draw limit of 2.3 Amps at a pulse of 4 milliseconds during the OMS and RGB image capture.

As shown in FIG. 16C, operation of the light emitters 24 may be similar with the mirror assembly having a prismatic mirror reflective element, and with the wFOV light emitter 24c operating fewer LEDs, such as one NIR LED. Because the wFOV light emitter 24c operates only one NIR LED during driver monitoring, occupant monitoring, and RGB image capture, the LED of the wFOV light emitter 24c is not operated under a cap and may operate at a current draw of about 2.8 Amps at a pulse of about 4 milliseconds. The light emitters 24, when operated, emit light that passes through the prismatic mirror reflective element to illuminate regions of the cabin of the vehicle.

With the NIR LEDs of the nFOV light emitters 24a, 24b pulsed on at a rate of 30 Hertz and the NIR LEDs of the wFOV light emitters 24c pulsed on at a rate of 5 Hertz, the camera may capture frames of image data representative of NIR light for driver monitoring and occupant monitoring, and frames of image data representative of visible light in a 12-step pattern (FIG. 16D). The pattern may capture frames of image data at a rate of 60 Hertz where a first frame is for driver monitoring, a second frame is for occupant monitoring and the third frame through twelfth frame alternate between driver monitoring capture and visible light capture, such that the third, fifth, seventh, ninth, and eleventh frames are for driver monitoring and the fourth, sixth, eighth, tenth and twelfth frames are representative of visible light. There may be a fifth of a second period between subsequent cycles.

FIGS. 17A-17F illustrate example irradiance results of the NIR light emitters 24 of FIGS. 16A-16C. As shown, the NIR light emitters 24 may have a current draw at a pulse of about 4 milliseconds that is about 1.21 times greater than other NIR light emitters and, with the vertically oriented red glow filter 26, the NIR light emitters 24 may achieve the same or improved signal to noise ratio (SNR) with the driver positioned at 700 millimeters or less from the interior rearview mirror assembly. For example, with the mirror assembly having an electrochromic mirror reflective element and under maximum energy conditions during driver monitoring, the NIR light emitters 24 may provide total optical power of 16.03 Watts at a current draw of 2.8 Amps with measured irradiance at the driver's head region of 4.976 W/m² (FIG. 17A). With the mirror assembly having a prismatic mirror reflective element and under maximum energy conditions during driver monitoring, the NIR light emitters 24 may provide total optical power of 10.08 Watts at a current draw of 2.3 Amps with measured irradiance at the driver's head region of 3.592 W/m² (FIG. 17B). With the mirror assembly having an electrochromic mirror reflective element and under maximum power conditions during driver monitoring, the NIR light emitters 24 may provide total optical power of 25.6 Watts at a current draw of 5 Amps with measured irradiance at the driver's head region of 13.12 W/m² (FIG. 17C). This current draw may be increased for a pulse of about 0.5 milliseconds. With the mirror assembly having a prismatic mirror reflective element and under maximum power conditions during driver monitoring, the NIR light emitters 24 may provide total optical power of 19.2 Watts at the increased current draw of 5 Amps for a pulse of about 0.5 milliseconds with measured irradiance at the driver's head region of 13.12 W/m² (FIG. 17D).

In some examples, the camera may include a filter that is a more efficient notch IR-only filter. Thus, with the mirror assembly having a prismatic mirror reflective element and under maximum energy conditions during driver monitoring, the NIR light emitters 24 may provide total optical power of 8.01 Watts at a current draw of 2.8 Amps with measured irradiance at the driver's head region of 3.592 W/m² (FIG. 17E). With the mirror assembly having the camera filter and a prismatic mirror reflective element and under maximum power conditions during driver monitoring, the NIR light emitters 24 may provide total optical power of 12.8 Watts at the increased current draw of 5 Amps for a pulse of about 0.5 milliseconds with measured irradiance at the driver's head region of 13.12 W/m² (FIG. 17F). Optionally, the camera may only capture image data representative of IR or NIR light, and visible light may be blocked or reflected away from the camera by the prismatic mirror reflective element and/or one or more filters at the camera.

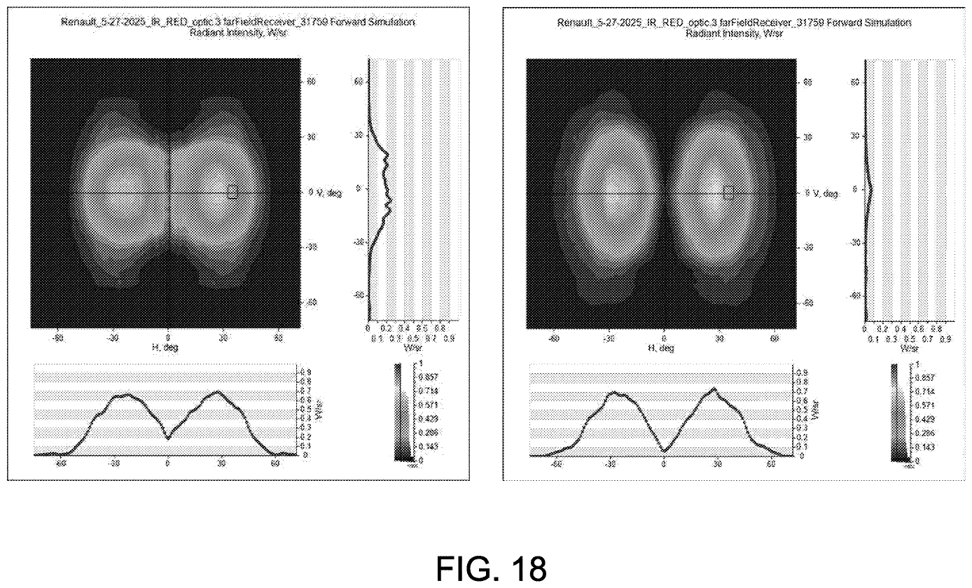

Referring to FIGS. 5D and 18, the red glow filter 26 may include one or more prism features or stepped optic elements, which cause light emitted by the light emitter 24 to be directed radially outboard of the LED of the light emitter 24 toward the driver side and/or passenger side of the vehicle (or the driver sides of both LHD and RHD vehicles). Without these prism features, at least some light may be directed toward a central region of the vehicle (e.g., perpendicular to the plane of the PCB) and the amount of light directed toward the drivers is reduced, making the optic less efficient.

Thus, the system may replace the LED PCB with LEDs on the main ECU PCB by utilizing a red glow filter with optics or lens portions. This maintains NIR irradiance in at least the driver region of the vehicle. Moreover, a camera with a reduced field of view and reduced resolution may be used to achieve coverage for drivers with a camera angular resolution greater than or equal to about 20 pixels/degrees. The system may reduce the cost of DMS/OMS systems with substantially the same or improved functionality.

The red glow filter may be configured to provide exit surfaces for the IR or NIR light emitted by the light sources without making the light more visibly noticeable to the driver of the vehicle. Further, the optic may provide substantially uniform irradiance distribution. In some examples with the prismatic mirror reflective element, a two LED solution (e.g., where one or more of the NIR light emitters 24 includes only two NIR LEDs) may require management of ARR risk, such that the camera may only capture image data representative of IR or NIR light. A three-LED solution may provide less risk.

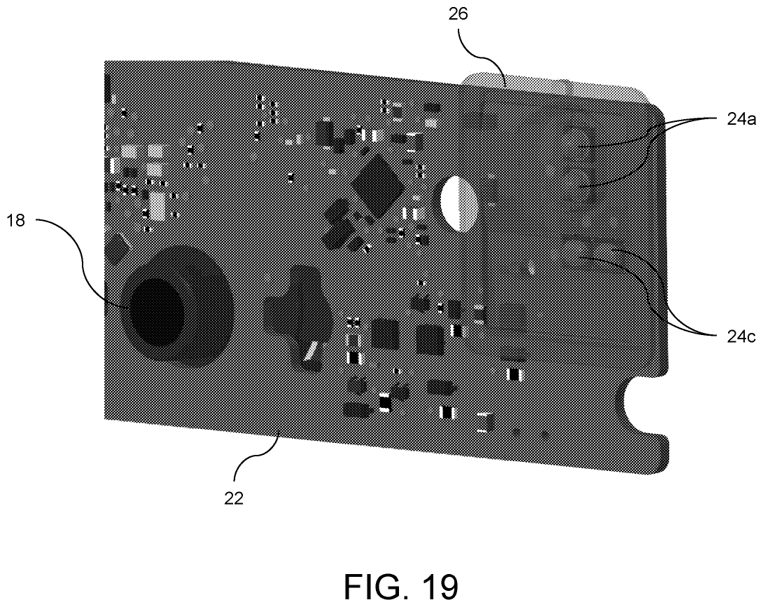

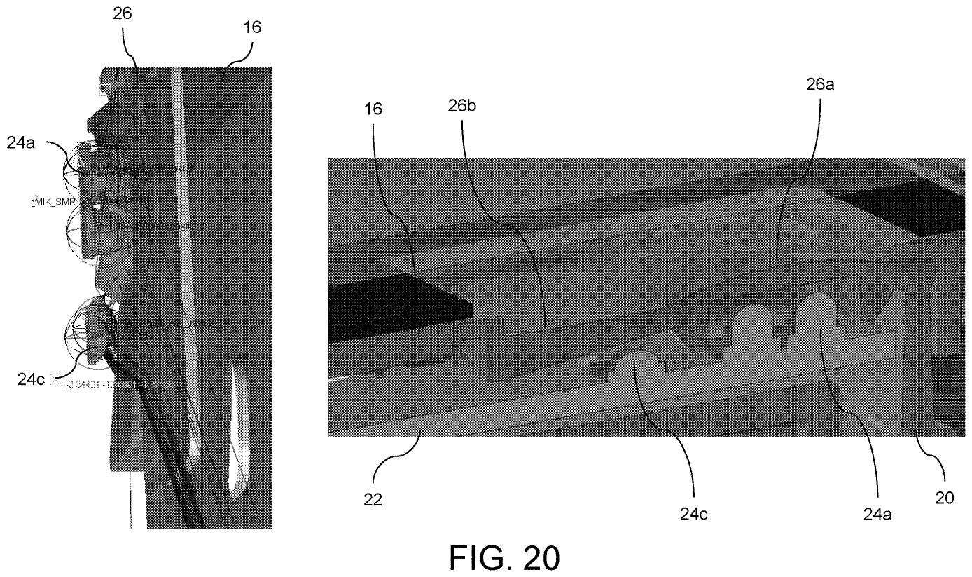

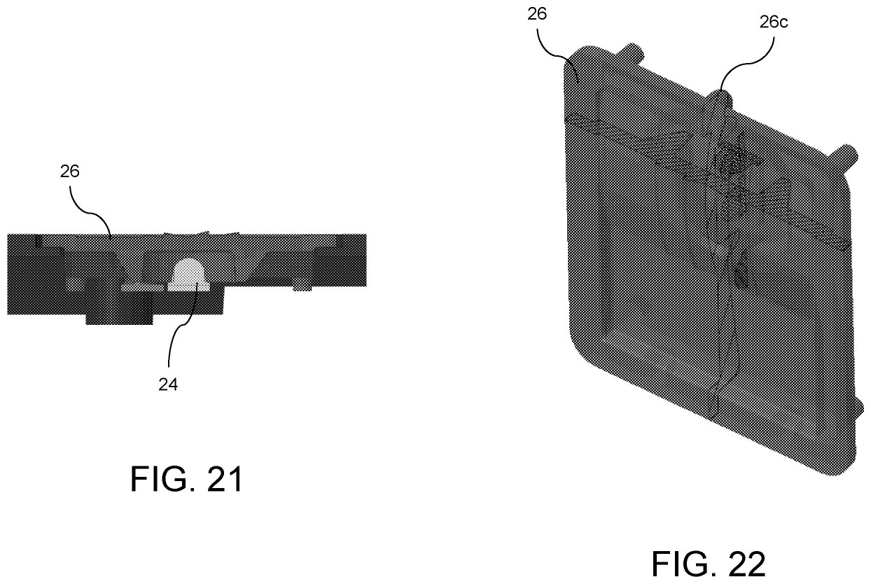

Referring to FIGS. 19-23, the NIR light emitters 24 may be disposed at the side portion of the PCB 22, with nFOV light emitters vertically stacked relative to one another and wFOV light emitters disposed next to one another below the nFOV light emitters. Accordingly, the nFOV light emitters 24a may be used for both left hand drive vehicles and right hand drive vehicles instead of requiring separate nFOV light emitters for LHD vehicles versus RHD vehicles. The wFOV light emitters 24c are disposed beneath the vertically stacked nFOV light emitters 24a along the side region of the PCB 22 (e.g., along one side of the PCB 22 with the camera 18 disposed at a central region of the PCB 22). The red glow filter 26 with optic elements may be configured to extend the field of illumination of the wFOV light emitters 24c further downward from the mirror head. For example, the field of illumination may extend up to 70 degrees or more downward from the mirror head, such as up to 82.5 degrees downward from the mirror head or more. Additionally, the portion of the optic element 26 adjacent the mirror reflective element 14 may be smoother, reducing visibility of the optic element 26 and light emitters 24 through the mirror reflective element 14 to the driver of the vehicle.

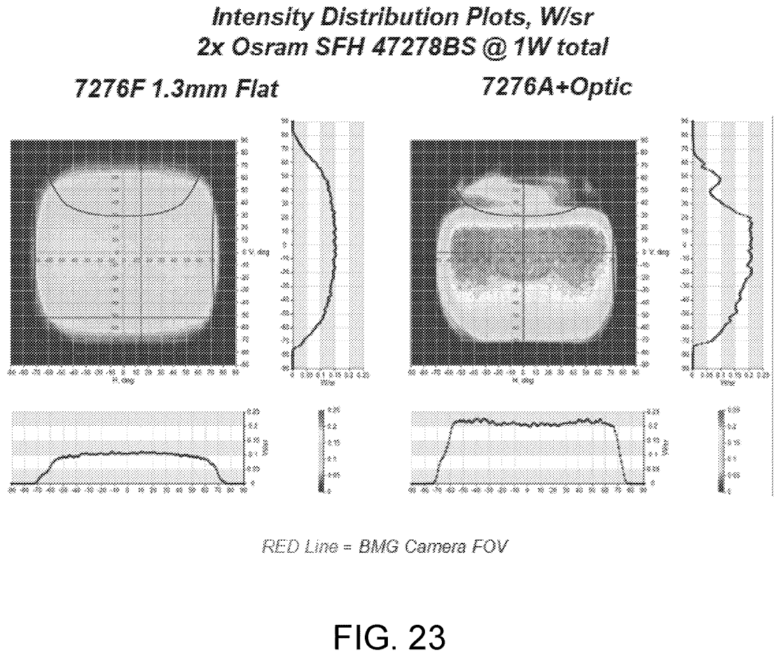

The red glow filter with optic element 26 may include a convex lens optic portion 26a and light emitted by the nFOV light emitters 24a passes through the convex lens optic portion 26a so that light emitted along a principal beam axis perpendicular to the PCB 22 is directed at other angles and passes through the mirror reflective element 14 to illuminate the driver regions of the interior cabin. Further, the optic element 26 includes a prism lens optic portion 26b that extends downward from the convex lens optic portion 26a and over the wFOV light emitters 24c. The prism portion 26b has an outer surface parallel to the mirror reflective element and an inner surface that tapers toward the convex lens optic portion 26a. Thus, the prism shape helps reduce the air gap between the optic 26 and the light emitters 24 and spreads light from the wFOV light emitters 24c downward so that less light is emitted toward the headliner. For example, and as shown in FIG. 23, IR light emitted by the wFOV light emitters 24c may extend about 70 degrees downward from the camera head while the camera field of view may extend downward about 82.5 degrees downward from the mirror head. One or more alignment elements or pins 26c may be received at the attachment plate 20 or PCB 22 of the mirror assembly for aligning the red glow optic element 26 with the light emitters 24.

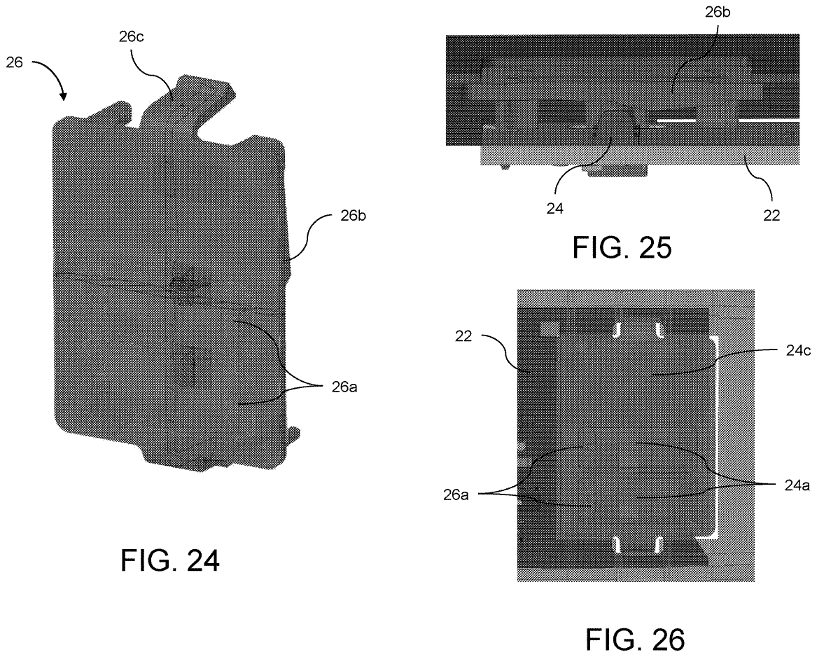

Referring to FIGS. 24-30, the NIR light emitters 24 may be disposed at the side portion of the PCB 22, with nFOV light emitters vertically stacked relative to one another and wFOV light emitters disposed next to one another above the nFOV light emitters. Accordingly, the nFOV light emitters 24a may be used for both left hand drive vehicles and right hand drive vehicles instead of requiring separate nFOV light emitters for LHD vehicles versus RHD vehicles. The wFOV light emitters 24c are disposed above the vertically stacked nFOV light emitters 24a along the side region of the PCB 22 (e.g., along one side of the PCB 22 with the camera 18 disposed at a central region of the PCB 22). The red glow filter 26 with optic elements may be configured to extend the field of illumination of the wFOV light emitters 24c further downward from the mirror head. For example, the field of illumination may extend up to 82.5 degrees downward from the mirror head or more, up to 90 degrees downward from the mirror head or more, and the like. Additionally, the portion of the optic element 26 adjacent the mirror reflective element 14 may be smoother or flattened, reducing visibility of the optic element 26 and light emitters 24 through the mirror reflective element 14 to the driver of the vehicle.

For example, and as shown in FIGS. 24-26, a first portion or convex lens optic portion 26a of the red glow optic element 26 includes respective bumps or convex lens portions in front of the nFOV light emitters 24a so that light emitted by the nFOV light emitters 24a passes through the convex lens optic portion 26a and the light emitted along a principal beam axis perpendicular to the PCB 22 is directed at other angles and passes through the mirror reflective element 14 to illuminate the driver regions of the interior cabin. Moreover, the convex lens portion 26a may improve the brightness of the NIR light emitted by the nFOV light emitters 24a when illuminating the interior cabin. The convex lens portion 26a may face the mirror reflective element 14. For example, the convex lens portion 26a may include bumps that are raised about 0.25 millimeters from the surface of the optic element 26. The nFOV light emitters 24a may be vertically offset or slightly above the convex lens portion 26a so that a greater proportion of light emitted by the nFOV light emitters 24a is aimed downward from the mirror head. For example, the nFOV light emitters 24a are disposed about 0.3 millimeters (e.g., between about 0.1 millimeters and 0.5 millimeters) above the center of the raised portion of the convex lens portion 26a.

A second optic portion or prism lens portion 26b of the red glow optic element 26 may include a Fresnel splitting lens so that light emitted by the wFOV light emitters 24a passes through the prism lens portion 26b so that light emitted along a principal beam axis perpendicular to the PCB 22 is directed at other angles and passes through the mirror reflective element 14 to illuminate portions of the interior cabin. The prism lens portion 26b may be at a side of the red glow filter optic element 26 that faces the wFOV light emitters 24c so that the side of the red glow filter optic element 26 that faces the mirror reflective element 14 may be flat. This may reduce visibility of the red glow filter 26 and light emitters 24 through the mirror reflective element 14. One or more alignment elements or pins or snaps 26c may be received at the attachment plate 20 or PCB 22 of the mirror assembly for aligning the red glow optic element 26 with the light emitters 24.

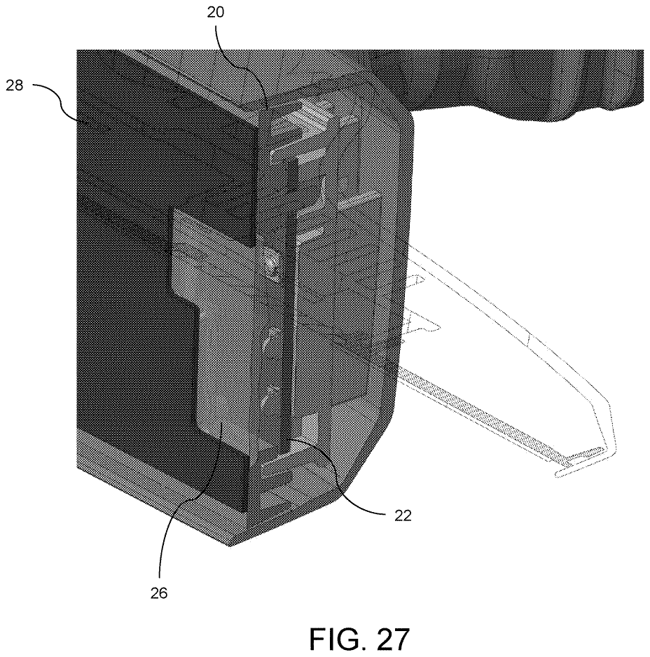

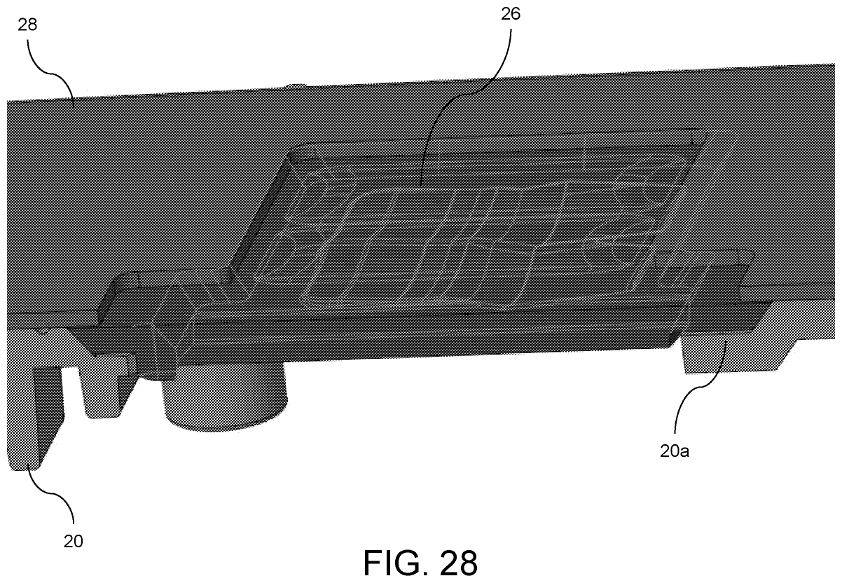

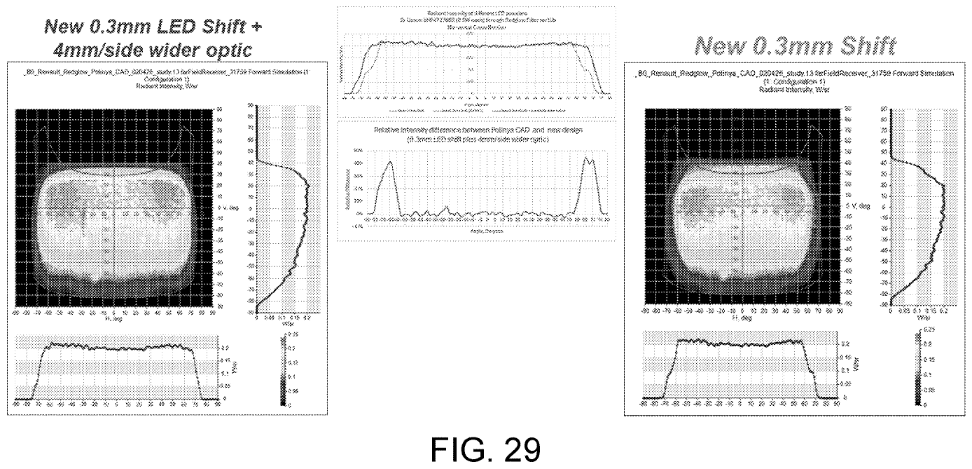

As shown in FIGS. 27 and 28, the red glow optic element 26 is installed in the mirror head between the PCB 22 and an interior side of the mirror reflective element 14. The mirror reflective element 14 may be attached to the mirror back plate 20 via an adhesive or adhesive tape 28 and the red glow optic element 26 may also be attached to the mirror back plate 20 via the adhesive or adhesive tape 28 to extend over and along the PCB 22. For example, a receiving portion 20a of the back plate 20 may be recessed from an attaching surface of the mirror back plate 20 that attaches to the mirror reflective element 14 and the receiving portion 20a is configured to accommodate the optic 26 between the mirror back plate 20 and the adhesive tape 28. The optic 26 aligns with an aperture formed through the adhesive tape 28. The receiving portion 20a may include a tapered or sloped edge that extends from the attaching surface and the red glow optic element 26 may include a tapered or wedge-shaped peripheral edge that corresponds to the sloped edge of the receiving portion 20a. For example, the sloped edge may extend at an angle of about 52 degrees (e.g., between about 30 degrees and 60 degrees) to constrain the optic 26 to the attachment plate 20 with a gap between the optic 26 and the LEDs 24 at the PCB 22 to help align the LEDs 24 and the optical surfaces. This allows the red glow filter optic element 26 to be assembled from the inner side of the mirror reflective element and for the adhesive tape 28 to hold the filter 26 in place. The edge of the red glow filter optic element 26 may be offset from the primary axis of illumination from the LEDs 24, such as by 1.5 millimeters or more, 3 millimeters or more, 4 millimeters or more, and the like, to prevent light blockage. FIG. 29 depicts an example field of illumination of the NIR LEDs disposed behind the red glow optic element 26 of FIGS. 24-28.

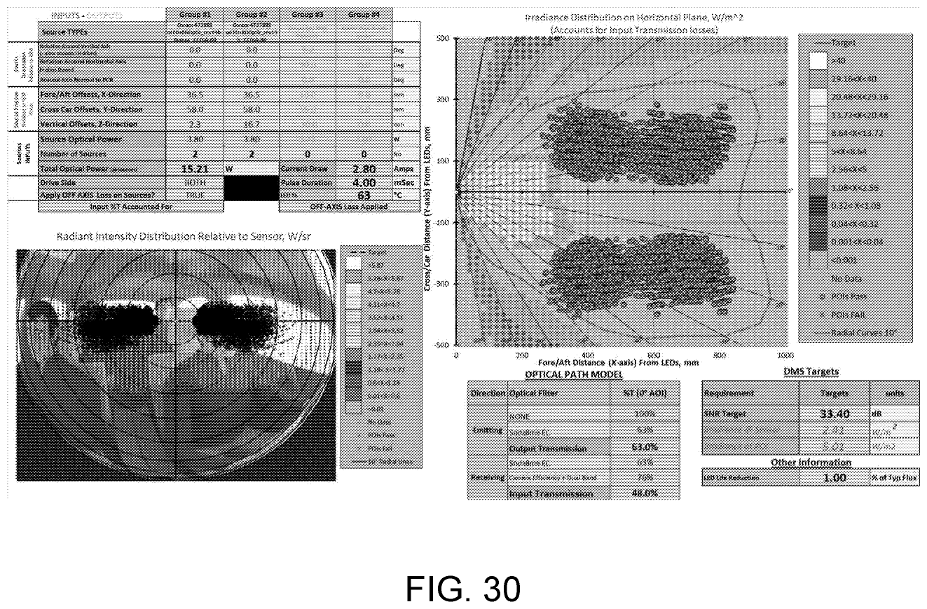

FIG. 30 illustrates example irradiance results of the NIR light emitters 24 of FIGS. 24-28. As shown, the NIR light emitters 24 may have a current draw at a pulse of about 4 milliseconds that is about 2.8 Amps. Under maximum energy conditions during driver monitoring, the NIR light emitters 24 may provide total optical power of 15.21 Watts at a current draw of 2.8 Amps with a temperature of the LEDs reaching about 63 degrees Celsius.

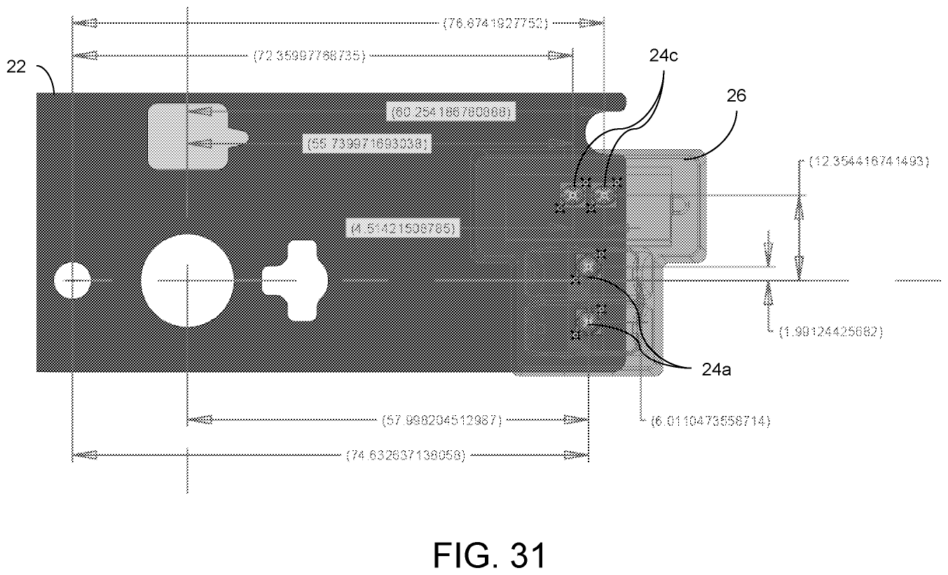

FIG. 31 shows example dimensions of the PCB 22, light emitters 24a, 24c and the red glow optic element 26. As shown, the nFOV light emitters 24a may be laterally offset at the PCB 22 from a center point of the camera 18 by about 57.998 millimeters, with a center point of an upper nFOV light emitter 24a disposed about 1.991 millimeters above the center point of the camera 18, and a center point of a lower nFOV light emitter 24a disposed about 6.011 millimeters below the center point of the camera 18. A first wFOV light emitter 24c is laterally offset from the center point of the camera 18 by about 55.740 millimeters and a second wFOV light emitter 24c is laterally offset from the center point of the camera 18 by about 60.254 millimeters and the wFOV light emitters 24c are disposed above the center point of the camera 18 by about 12.354 millimeters.

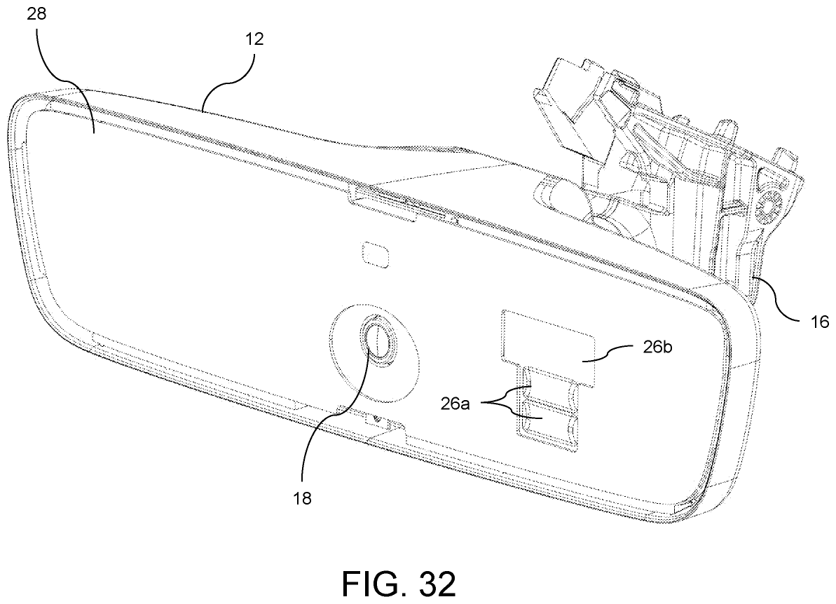

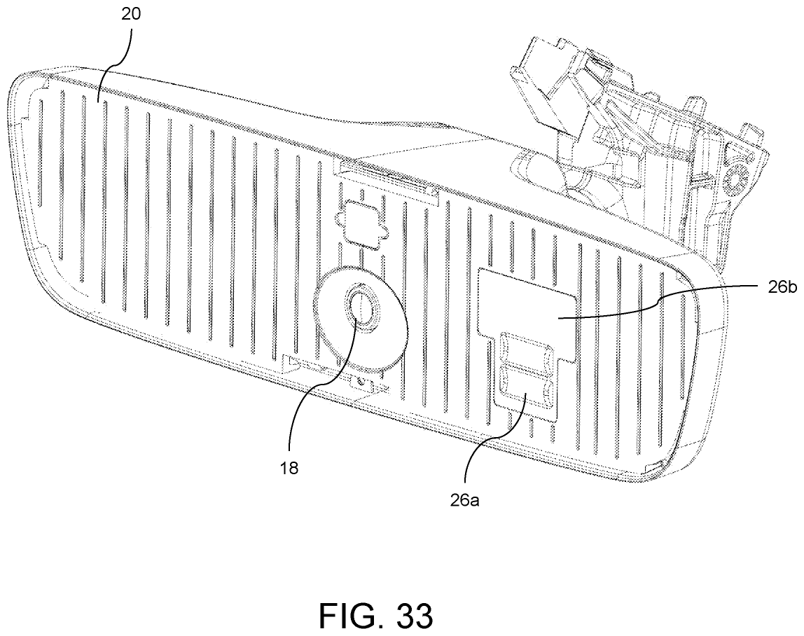

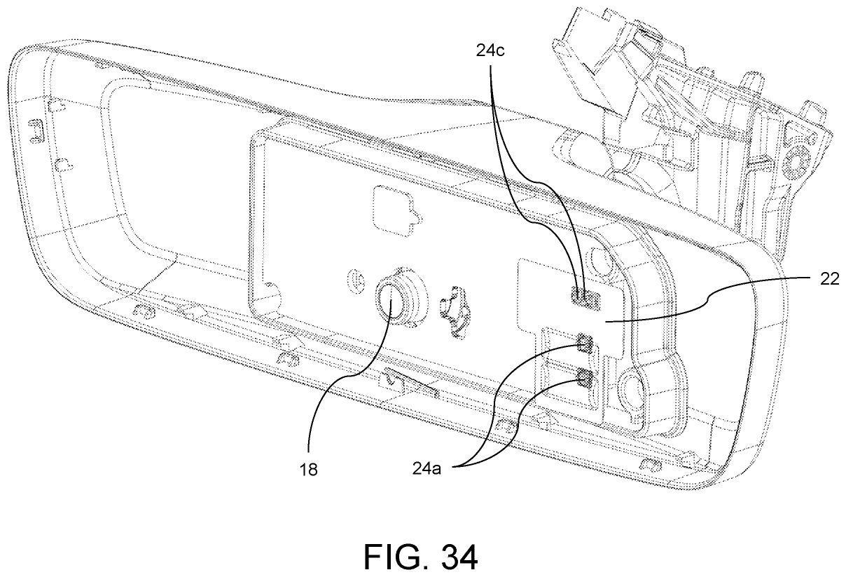

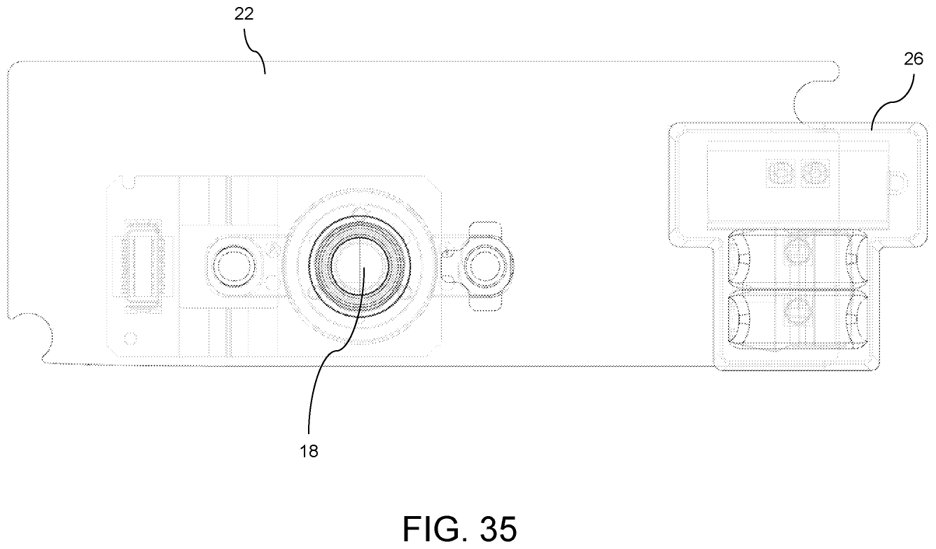

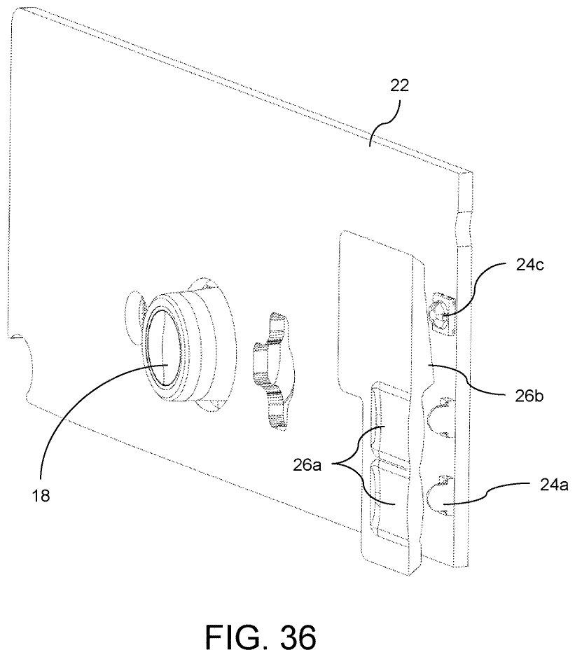

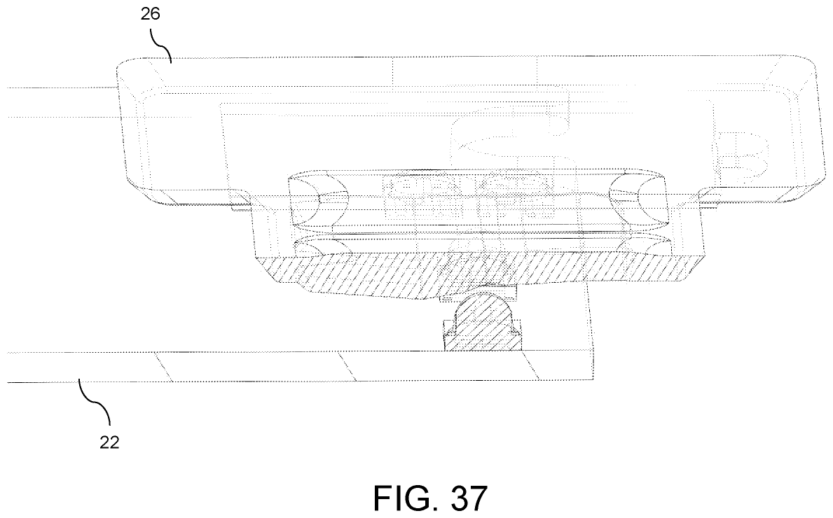

Thus, and as shown in FIGS. 32-37, the mirror assembly 10 includes a mirror casing 12 that accommodates a PCB 22. The camera 18 and the light emitters 24 may be disposed at the same PCB 22, or the camera 18 may be disposed at a separate imager PCB disposed behind the PCB 22 at which the light emitters 24 are disposed, such that the camera 18 may view through an aperture in the PCB 22. The PCB(s) are disposed between a mirror attachment plate 20 and an interior surface of the mirror casing 12, such that the camera 18 views through an aperture in the attachment plate 20 and the light emitters 24 emit NIR light that passes through another aperture in the attachment plate 20. The mirror reflective element 14 attaches to the mirror attachment plate 20 via an adhesive element or tape 28. The camera 18 views through an aperture in the adhesive tape 28 and through the mirror reflective element 14. A red glow filter optic element 26 is disposed between the attachment plate 20 and the adhesive element 28 and is secured via the adhesive element 28. The red glow filter optic element 26 is disposed in front of the NIR light emitters 24 such that light emitted by the NIR light emitters 24 passes through the red glow filter optic element 26 and the mirror reflective element 14 to illuminate the interior cabin of the vehicle.

In the illustrated example, the mirror assembly 10 includes one or more nFOV light emitters 24a and one or more wFOV light emitters 24c. The nFOV light emitters 24a are vertically stacked relative to one another and disposed beneath the wFOV light emitters 24c, which are disposed next to one another. The light emitters 24 are disposed along a side portion of the mirror head (e.g., toward a passenger side of the vehicle for a left hand driver vehicle), but the mirror assembly may provide NIR light illumination for the driver region, passenger region, and footwell regions for LHD vehicles and RHD vehicles.

The red glow filter optic element 26 includes a first portion 26a disposed in front of the nFOV light emitters 24a and a second portion 26b disposed in front of the wFOV light emitters 24c. The first portion 26a may include one or more convex lens portions for redirecting or angling light emitted by the nFOV light emitters 24a toward portions of the interior cabin. That is, the nFOV light emitters 24a may emit light with a primary beam axis perpendicular to the PCB 22 and the first portion 26a may direct light that passes through the first portion 26a with a beam axis at an oblique angle relative to the PCB 22 (e.g., angled more toward the driver side of the vehicle). This redirected light passes through the mirror reflective element 14, such as to illuminate the driver region of the interior cabin of the vehicle. The second portion 26b may include one or more prismatic lens portions for redirecting or angling light emitted by the wFOV light emitters 24c toward portions of the interior cabin. The second portion 26b may have faceted surfaces facing the LEDs and a flat surface facing the mirror reflective element 14. The wFOV light emitters 24c may emit light with a primary beam axis perpendicular to the PCB 22 and the second portion 26b may direct light that passes through the second portion 26b with a beam axis at an oblique angle relative to the PCB 22 (e.g., downward from the mirror head). This redirected light passes through the mirror reflective element 14, such as to illuminate the passenger region of the interior cabin and/or footwell regions of the interior cabin.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

As discussed above, the mirror assembly may comprise an electro-optic or electrochromic mirror assembly that includes an electro-optic or electrochromic variably reflective mirror reflective element. The perimeter edges of the reflective element may be encased or encompassed by the perimeter element or portion of the bezel portion to conceal and contain and envelop the perimeter edges of the substrates and the perimeter seal disposed therebetween. The variably reflective mirror reflective element of the mirror assembly may utilize aspects of the mirror reflective elements described in commonly assigned U.S. Pat. Nos. 7,626,749; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, and/or U.S. Publication No. US-2022-0371513, which are hereby incorporated herein by reference in their entireties.

Although shown as an electrochromic mirror application, it is envisioned that the mirror assembly may comprise a prismatic reflective element. The prismatic mirror assembly may be mounted or attached at an interior portion of a vehicle (such as at an interior surface of a vehicle windshield) via the mounting means described above, and the reflective element may be toggled or flipped or adjusted between its daytime reflectivity position and its nighttime reflectivity position via any suitable toggle means, such as by utilizing aspects of the mirror assemblies described in U.S. Pat. No. 6,318,870 and/or 7,249,860, and/or U.S. Publication No. US-2010-0085653, which are hereby incorporated herein by reference in their entireties. Optionally, for example, the interior rearview mirror assembly may comprise a prismatic mirror assembly, such as the types described in U.S. Pat. Nos. 7,289,037; 7,249,860; 6,318,870; 6,598,980; 5,327,288; 4,948,242; 4,826,289; 4,436,371 and/or 4,435,042, which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,289,037; 7,274,501; 7,249,860; 7,338,177 and/or 7,255,451, which are all hereby incorporated herein by reference in their entireties.

The mirror assembly may include a camera or sensor or light of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 12,403,834; 12,393,089; 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2025-0329174; US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2026/019985 and/or WO 2025/231198 and/or International Patent Application Ser. No. PCT/US2026/012509, filed Jan. 26, 2026 (Attorney Docket MAG04 FP5522WO), which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Changes and modifications in the specifically described embodiments may be carried out without departing from the principles of the present invention, which is intended to be limited only by the scope of the appended claims as interpreted according to the principles of patent law.

1. A vehicular cabin monitoring system, the vehicular cabin monitoring system comprising:
a vehicular interior rearview mirror assembly comprising a mirror head adjustable relative to a mounting structure, wherein the mounting structure is configured to mount the vehicular interior rearview mirror assembly at an interior portion of an interior cabin of a vehicle;
wherein the mirror head accommodates a mirror reflective element;
wherein a camera is accommodated by the mirror head, and wherein, with the vehicular interior rearview mirror assembly mounted at the interior portion of the interior cabin of the vehicle, the camera views within the interior cabin of the vehicle;
wherein a near infrared (NIR) light emitter is accommodated by the mirror head, and wherein the NIR light emitter comprises an NIR light source that, with the vehicular interior rearview mirror assembly mounted at the interior portion of the interior cabin of the vehicle, and when the NIR light emitter is electrically operated, emits NIR light that illuminates at least a portion of the interior cabin of the vehicle;
wherein the camera, the NIR light emitter and the mirror reflective element move together and in tandem with the mirror head when, with the vehicular interior rearview mirror assembly mounted at the interior portion of the interior cabin of the vehicle, the mirror head is adjusted about the mounting structure to provide a rearward view for a driver of the vehicle provided by the mirror reflective element;
an electronic control unit (ECU);
wherein image data captured by the camera is transferred to the ECU;
wherein the ECU comprises electronic circuitry and associated software, and wherein the electronic circuitry of the ECU comprises an image processor operable to process image data transferred to the ECU;
wherein an optic element is disposed between the NIR light source and a rear side of the mirror reflective element, and wherein, with the vehicular interior rearview mirror assembly mounted at the interior portion of the interior cabin of the vehicle, and when the NIR light emitter is electrically operated, NIR light emitted by the NIR light source (i) passes through the optic element, (ii) passes through the mirror reflective element and (iii) is directed at least partially toward a driver side of the interior cabin of the vehicle;
wherein the NIR light emitted by the NIR light source as entering the optic element has an initial principal beam axis at a first angle relative to the rear side of the mirror reflective element, and wherein the NIR light emitted by the NIR light source as exiting the optic element has an adjusted principal beam axis at a second angle relative to the rear side of the mirror reflective element different from the first angle; and
wherein, with the vehicular interior rearview mirror assembly mounted at the interior portion of the interior cabin of the vehicle, image data captured by the camera is processed at the ECU for monitoring at least the driver of the vehicle.

2. The vehicular cabin monitoring system of claim 1, wherein, with the vehicular interior rearview mirror assembly mounted at the interior portion of the interior cabin of the vehicle, the second angle is more toward the driver side of the interior cabin of the vehicle than the first angle.

3. The vehicular cabin monitoring system of claim 1, wherein, with the vehicular interior rearview mirror assembly mounted at the interior portion of the interior cabin of the vehicle, the second angle is more downward from the mirror head than the first angle.

4. The vehicular cabin monitoring system of claim 1, wherein the NIR light emitter comprises (i) a first NIR light source configured to emit NIR light that is directed at least partially toward a left hand side of the interior cabin of the vehicle via the optic element and (ii) a second NIR light source configured to emit NIR light that is directed at least partially toward a right hand side of the interior cabin of the vehicle via the optic element.

5. The vehicular cabin monitoring system of claim 4, wherein the first NIR light source is configured to direct NIR light at least partially toward the driver side of the interior cabin of the vehicle when installed in a left hand drive vehicle, and wherein the second NIR light source is configured to direct NIR light at least partially toward the driver side of the interior cabin of the vehicle when installed in a right hand drive vehicle.

6. The vehicular cabin monitoring system of claim 4, wherein the NIR light emitter further comprises a third NIR light source configured to emit NIR light that illuminates at least a passenger region of the interior cabin of the vehicle.

7. The vehicular cabin monitoring system of claim 4, wherein, with the vehicular interior rearview mirror assembly mounted at the interior portion of the interior cabin of the vehicle, the first NIR light source is disposed above the second NIR light source.

8. The vehicular cabin monitoring system of claim 7, wherein the NIR light emitter further comprises a third NIR light source configured to emit NIR light that illuminates at least a passenger region of the interior cabin of the vehicle, and wherein, with the vehicular interior rearview mirror assembly mounted at the interior portion of the interior cabin of the vehicle, the third NIR light source is disposed above the first NIR light source and the second NIR light source.

9. The vehicular cabin monitoring system of claim 1, wherein, with the vehicular interior rearview mirror assembly mounted at the interior portion of the interior cabin of the vehicle, image data captured by the camera is processed at the ECU for monitoring a passenger of the vehicle.

10. The vehicular cabin monitoring system of claim 1, wherein the camera views through the mirror reflective element.

11. The vehicular cabin monitoring system of claim 1, wherein the mirror reflective element comprises an electrochromic mirror reflective element.

12. The vehicular cabin monitoring system of claim 1, wherein the mirror reflective element comprises a prismatic mirror reflective element.

13. The vehicular cabin monitoring system of claim 1, wherein the first angle comprises 90 degrees, and wherein the second angle comprises an oblique angle.

14. The vehicular cabin monitoring system of claim 1, wherein the optic element comprises a red glow filter.

15. The vehicular cabin monitoring system of claim 1, wherein the optic element comprises a Fresnel lens.

16. The vehicular cabin monitoring system of claim 1, wherein the NIR light emitter comprises a plurality of NIR light sources operable to emit NIR light.

17. A vehicular cabin monitoring system, the vehicular cabin monitoring system comprising:
a vehicular interior rearview mirror assembly comprising a mirror head adjustable relative to a mounting structure, wherein the mounting structure is configured to mount the vehicular interior rearview mirror assembly at an interior portion of an interior cabin of a vehicle;
wherein the mirror head accommodates a mirror reflective element;
wherein a camera is accommodated by the mirror head, and wherein, with the vehicular interior rearview mirror assembly mounted at the interior portion of the interior cabin of the vehicle, the camera views through the mirror reflective element and within the interior cabin of the vehicle;
wherein a near infrared (NIR) light emitter is accommodated by the mirror head, and wherein the NIR light emitter comprises a plurality of NIR light sources that, with the vehicular interior rearview mirror assembly mounted at the interior portion of the interior cabin of the vehicle, and when the NIR light emitter is electrically operated, emit NIR light that illuminates at least a portion of the interior cabin of the vehicle;
wherein the camera, the NIR light emitter and the mirror reflective element move together and in tandem with the mirror head when, with the vehicular interior rearview mirror assembly mounted at the interior portion of the interior cabin of the vehicle, the mirror head is adjusted about the mounting structure to provide a rearward view for a driver of the vehicle provided by the mirror reflective element;
an electronic control unit (ECU);
wherein image data captured by the camera is transferred to the ECU;
wherein the ECU comprises electronic circuitry and associated software, and wherein the electronic circuitry of the ECU comprises an image processor operable to process image data transferred to the ECU;
wherein an optic element is disposed between at least one NIR light source of the plurality of NIR light sources and a rear side of the mirror reflective element, and wherein, with the vehicular interior rearview mirror assembly mounted at the interior portion of the interior cabin of the vehicle, and when the NIR light emitter is electrically operated, NIR light emitted by the at least one NIR light source (i) passes through the optic element, (ii) passes through the mirror reflective element and (iii) is directed at least partially toward a driver side of the interior cabin of the vehicle;
wherein the NIR light emitted by the at least one NIR light source as entering the optic element has an initial principal beam axis at a first angle relative to the rear side of the mirror reflective element, and wherein the NIR light emitted by the at least one NIR light source as exiting the optic element has an adjusted principal beam axis at a second angle relative to the rear side of the mirror reflective element different from the first angle, and wherein, with the vehicular interior rearview mirror assembly mounted at the interior portion of the interior cabin of the vehicle, the second angle is more toward the driver side of the interior cabin of the vehicle than the first angle; and
wherein, with the vehicular interior rearview mirror assembly mounted at the interior portion of the interior cabin of the vehicle, image data captured by the camera is processed at the ECU for monitoring at least the driver of the vehicle.

18. The vehicular cabin monitoring system of claim 17, wherein the first angle comprises 90 degrees, and wherein the second angle comprises an oblique angle.

19. A vehicular cabin monitoring system, the vehicular cabin monitoring system comprising:
a vehicular interior rearview mirror assembly comprising a mirror head adjustable relative to a mounting structure, wherein the mounting structure is configured to mount the vehicular interior rearview mirror assembly at an interior portion of an interior cabin of a vehicle;
wherein the mirror head accommodates a mirror reflective element;
wherein a camera is accommodated by the mirror head, and wherein, with the vehicular interior rearview mirror assembly mounted at the interior portion of the interior cabin of the vehicle, the camera views within the interior cabin of the vehicle;
wherein a near infrared (NIR) light emitter is accommodated by the mirror head, and wherein the NIR light emitter comprises a plurality of NIR light sources that, with the vehicular interior rearview mirror assembly mounted at the interior portion of the interior cabin of the vehicle, and when the NIR light emitter is electrically operated, emit NIR light that illuminates at least a portion of the interior cabin of the vehicle;
wherein the camera, the NIR light emitter and the mirror reflective element move together and in tandem with the mirror head when, with the vehicular interior rearview mirror assembly mounted at the interior portion of the interior cabin of the vehicle, the mirror head is adjusted about the mounting structure to provide a rearward view for a driver of the vehicle provided by the mirror reflective element;
an electronic control unit (ECU);
wherein image data captured by the camera is transferred to the ECU;
wherein the ECU comprises electronic circuitry and associated software, and wherein the electronic circuitry of the ECU comprises an image processor operable to process image data transferred to the ECU;
wherein the plurality of NIR light sources comprises at least (i) a first NIR light source and (ii) a second NIR light source;
wherein an optic element comprises (i) a first portion disposed between the first NIR light source and a rear side of the mirror reflective element and (ii) a second portion disposed between the NIR light source and the rear side of the mirror reflective element;
wherein, with the vehicular interior rearview mirror assembly mounted at the interior portion of the interior cabin of the vehicle, and when the NIR light emitter is electrically operated, NIR light emitted by the first NIR light source (i) passes through the first portion of the optic element, (ii) passes through the mirror reflective element and (iii) is directed at least partially toward a driver side of the interior cabin of the vehicle;
wherein the NIR light emitted by the first NIR light source as entering the first portion of the optic element has an initial principal beam axis at a first angle relative to the rear side of the mirror reflective element, and wherein the NIR light emitted by the first NIR light source as exiting the first portion of the optic element has an adjusted principal beam axis at a second angle relative to the rear side of the mirror reflective element different from the first angle;
wherein, with the vehicular interior rearview mirror assembly mounted at the interior portion of the interior cabin of the vehicle, and when the NIR light emitter is electrically operated, NIR light emitted by the second NIR light source (i) passes through the second portion of the optic element, (ii) passes through the mirror reflective element and (iii) is directed at least partially toward a passenger side of the interior cabin of the vehicle;
wherein the NIR light emitted by the second NIR light source as entering the second portion of the optic element has an initial principal beam axis at a third angle relative to the rear side of the mirror reflective element, and wherein the NIR light emitted by the second NIR light source as exiting the second portion of the optic element has an adjusted principal beam axis at a fourth angle relative to the rear side of the mirror reflective element different from the third angle; and
wherein, with the vehicular interior rearview mirror assembly mounted at the interior portion of the interior cabin of the vehicle, image data captured by the camera is processed at the ECU for monitoring at least the driver of the vehicle and a passenger of the vehicle.

20. The vehicular cabin monitoring system of claim 19, wherein, with the vehicular interior rearview mirror assembly mounted at the interior portion of the interior cabin of the vehicle, the second angle is more toward the driver side of the interior cabin of the vehicle than the first angle and the fourth angle is more downward from the mirror head than the third angle.
